(19) United States
(12) Patent Application Publication
(10) Pub. No.: US 2018/0206282 A1
(43) Pub. Date: Jul. 19, 2018

(54) BEARER SPLITTING

(71) Applicant: Intel Corporation, Santa Clara, CA (US)

(72) Inventors: Sarabjot Singh, Santa Clara, CA (US); Mikhail Gerasimenko, Santa Clara, CA (US); Shu-Ping Yeh, Campbell, CA (US); Nageen Himayat, Fremont, CA (US)

(73) Assignee: Intel Corporation, Santa Clara, CA (US)

(21) Appl. No.: 15/743,403

(22) PCT Filed: Dec. 14, 2015
(86) PCT No.: PCT/US2015/065537

§ 371 Date: Jan. 10, 2018

Related U.S. Application Data
(60) Provisional application No. 62/191,861, filed on Jul. 13, 2015.

(51) Int. Cl. H04W 76/15; H04W 88/06; H04W 88/10; H04W 88/16

(52) U.S. Cl. CPC H04W 76/15; H04W 88/16; H04W 88/10; H04W 88/06

(57) ABSTRACT

A network device (e.g., an evolved Node B (eNB), user equipment (UE) or the like) can split a 3GPP bearer in a multi-radio heterogeneous network of a radio access network (RAN) between a plurality of communication links. The plurality of communication links can comprise a 3GPP link and one or more other multi-radio links of the multi-radio heterogeneous network. The bearer can be split dynamically or statically based on a plurality of heterogeneous network metrics. The network device can further determine the proportions, or ratios of traffic data to be transmitted between the plurality of communication links based on the proportions of the 3GPP bearer split and heterogeneous metrics.

### REFERENCE TO RELATED APPLICATIONS

This application claims the benefit of U.S. Provisional Application No. 62/191,861 filed Jul. 13, 2015, entitled “BEARER SPLITTING”, the contents of which are herein incorporated by reference in their entirety.

### FIELD

The present disclosure relates to wireless communications, and more specifically, to bearer splitting for wireless communications.

### BACKGROUND

Wireless mobile communication technology uses various standards and protocols to transmit data between a node (e.g., a transmission station) and a wireless device (e.g., a mobile device), or a user equipment (UE). Some wireless devices communicate using orthogonal frequency-division multiple access (OFDMA) in a downlink (DL) transmission and single carrier frequency division multiple access (SC-FDMA) in an uplink (UL) transmission. Standards and protocols that use orthogonal frequency-division multiplexing (OFDM) for signal transmission include the third generation partnership project (3GPP) long term evolution (LTE), the Institute of Electrical and Electronics Engineers (IEEE) 802.16 standard (e.g., 802.16e, 802.16m), which is commonly known to industry groups as WiMAX (Worldwide interoperability for Microwave Access), and the IEEE 802.11 standard, which is commonly known to industry groups as WiFi.

In 3GPP radio access network (RAN) LTE systems, the node can be a combination of Evolved Universal Terrestrial Radio Access Network (E-UTRAN) Node Bs (also commonly denoted as evolved Node Bs, enhanced Node Bs, eNodeBs, or eNBs) and Radio Network Controllers (RNCs), which communicates with the UE. The downlink (DL) transmission can be a communication from the node (e.g., eNB) to the UE, and the uplink (UL) transmission can be a communication from the wireless device to the node. In LTE, data can be transmitted from the eNodeB to the UE via a physical downlink shared channel (PDSCH). A physical uplink control channel (PUCCH) can be used to acknowledge that data was received. Downlink and uplink channels can use time-division duplexing (TDD) or frequency-division duplexing (FDD).

In homogeneous networks, the node, also called a macro node, can provide wireless coverage to wireless devices in a cell or cell network. The cell can be the area in which the wireless devices are operable to communicate with the macro node. Heterogeneous networks (HetNets) can be used to handle the increased traffic loads on the macro nodes due to increased usage and functionality of wireless devices. HetNets can include a layer of planned high power macro nodes (or macro eNBs) overlaid with layers of lower power nodes (small eNBs, micro-eNBs, pico-eNBs, femto-eNBs, home eNBs (HeNBs) or other network devices) that can be deployed in a less well planned or even entirely uncoordinated manner within the coverage area (cell) of a macro node. The lower power nodes (LPN s) can generally be referred to as “low power nodes”, small nodes, or small cells, for example.

### BRIEF DESCRIPTION OF THE DRAWINGS

FIG. 1 illustrates a block diagram illustrating an example radio access network (RAN) anchored wireless wireless local area network (WLAN) wireless communications network environment for a UE or eNB according to various aspects.

FIGS. 2A-2C illustrate protocol aggregation architectures applicable to the network environments, devices and processes according to various aspects or embodiments being disclosed.

FIG. 3 illustrates another wireless communications network system for a UE or eNB according to various aspects.

FIG. 4 illustrates process flow mechanisms to update splitting ratios based on feedback of metrics according to various aspects.

FIG. 5 illustrates a process flow to update splitting ratios based on feedback of metrics according to various aspects.

FIG. 6 illustrates another process flow mechanisms to update splitting ratios based on feedback of metrics according to various aspects.

FIG. 7 illustrates another process flow mechanisms to update splitting ratios based on feedback of metrics according to various aspects.

FIG. 8 illustrates additional process flow mechanisms to update splitting ratios based on feedback of metrics according to various aspects.

FIG. 9 illustrates a call flow for exchanging feedback between an eNB and a WLAN termination point according to various aspects.

FIG. 10 illustrates another call flow for exchanging feedback between an eNB and a WLAN termination point according to various aspects.

FIG. 11 illustrates an example status report for UE feedback on WLAN related measurements according to various aspects.

FIG. 12 illustrates another example status report for UE feedback on WLAN related measurements according to various aspects.

FIG. 13 illustrates another process flow to update splitting ratios based on feedback of metrics according to various aspects.

FIG. 14 is a block diagram illustrating an example user equipment (UE) useable in connection with various aspects described herein.

FIG. 15 is a block diagram of an enhanced node B (eNB) or other network device that facilitates bearer splitting according to various aspects described herein

### DETAILED DESCRIPTION

The present disclosure will now be described with reference to the attached drawing figures, wherein like reference numerals are used to refer to like elements throughout, and wherein the illustrated structures and devices are not necessarily drawn to scale. As utilized herein, terms “component,” “system,” “interface,” and the like are intended to refer to a computer-related entity, hardware, software (e.g., in execution), and/or firmware. For example, a component can be a processor, a process running on a processor, a controller, a circuit or a circuit element, an object, an executable, a program, a storage device, a computer, a tablet PC and/or a mobile phone with a processing device. By way of illustration, an application running on a server and the server can also be a component. One or more components can reside within a process, and a component can be localized on one computer and/or distributed between two or more computers. A set of elements or a set of other components can be described herein, in which the term “set” can be interpreted as “one or more.”

Further, these components can execute from various computer readable storage media having various data structures stored thereon such as with a module, for example. The components can communicate via local and/or remote processes such as in accordance with a signal having one or more data packets (e.g., data from one component interacting with another component in a local system, distributed system, and/or across a network, such as, the Internet, a local area network, a wide area network, or similar network with other systems via the signal).

As another example, a component can be an apparatus with specific functionality provided by mechanical parts operated by electric or electronic circuitry, in which the electric or electronic circuitry can be operated by a software application or a firmware application executed by one or more processors. The one or more processors can be internal or external to the apparatus and can execute at least a part of the software or firmware application. As yet another example, a component can be an apparatus that provides specific functionality through electronic components or elements without mechanical parts; the electronic components can include one or more processors therein to execute software and/or firmware that confer(s), at least in part, the functionality of the electronic components.

Use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description and the claims, such terms are intended to be inclusive in a manner similar to the term “comprising”.

In consideration of the above described deficiencies, “push based” mechanisms and processes are disclosed to dynamically split traffic (e.g., the bearer traffic data) across multiple radio access and UEs in order to minimize or equalize relative transmission delays across multiple links. “Push” technology generally refers to a means to transmit information to one or more devices without a previous user action. Thus, an explicit request from the client is not required before the server or UE transmits its information, and therefore push technology can include server or UE initiated transactions.

In one example of the disclosure, a network device, such as an eNB or UE can be communicatively coupled to a multi-radio heterogeneous network of a radio access network (RAN). The multi-radio heterogeneous network can comprise various multi-radio connections of radio access technologies (RAT)s, such as 3GPP, LTE, 5G mm-wave RAT, WiGiG, legacy 3GPP RATs, multi-link carrier and secondary cell aggregation within the same RAT, or other RATs with one or more UEs, one or more access points (AP)s, or other network devices. The network device can comprise a proportion component that determines different data amounts (or portions) of a bearer (e.g., a 3GPP bearer) to be sent over different communication links of the multi-radio heterogeneous network, such as a 3GPP link and other multi-radio links of one or more different RATs. The bearer traffic can then be transmitted according to the different amounts of the bearer.

In one example, the particular data amounts of the bearer can be determined based on various heterogeneous network metrics. The network device can further include a splitter component that separates (splits) the bearer into the different data amounts corresponding to the communication links. The network device can then provide the different data amounts of the 3GPP bearer over the communication links according to the split amount of the bearer. The communication links can be different from one another or the same, comprising, for example, a 3GPP communication link and one or more other multi-radio links of the multi-radio heterogeneous network.

The operations disclosed can be based on minimizing or equalizing the relative transmission delays across multiple links. The optimal solutions for the targeted metrics can lend themselves to iterative processes as solutions, which rely on minimal exchange of information related to the state of the WLAN RATs, thereby making them especially amenable to implementation with non-collocated WLAN/LTE deployments. The embodiments disclosed, however, are not limited to non-collocated network deployments and can include co-located deployments as well in order to further decrease time delay for a network device communicatively coupled to a multi-radio heterogeneous network of a radio access network (RAN) via a plurality of communication links.

In one aspect, an upgrade to the WLAN AP can include a control interface to be present between the WLAN AP and eNB, while in other aspects of the disclosure there is no upgrade to the existing WLAN APs (in line with current discussions within 3GPP). The proposed embodiments can be applicable to all protocol aggregation configuration options, as well as address downlink (DL) and uplink (UL) bearer split operations for both collocated and non-collocated eNB/WLAN deployments. The processes or operation disclosed can be dynamic and allow for splitting decisions based on real-time measurements of heterogeneous network metrics, accounting for link quality, congestion, propagation delays, and traffic requirements for each user across LTE and WLAN, for example.

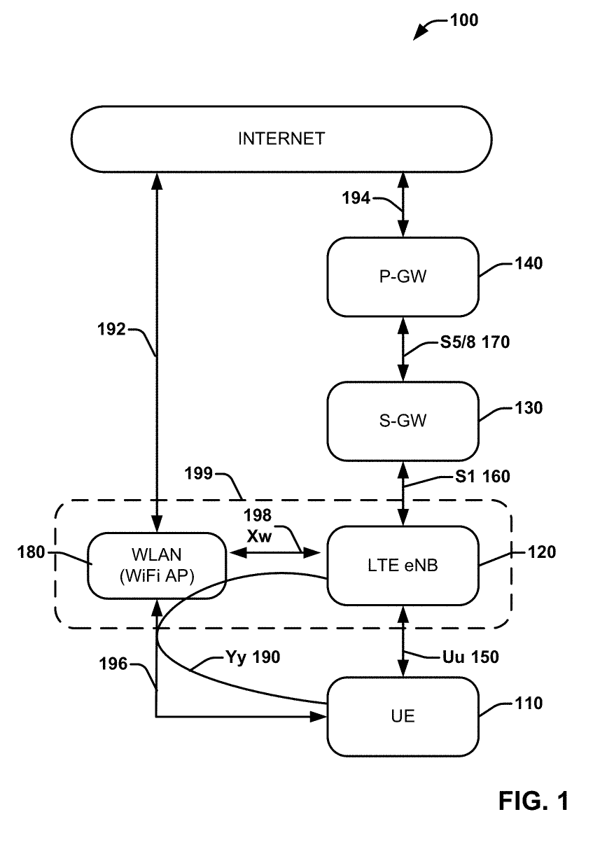

FIG. 1 illustrates a 3GPP RAN anchored WLAN network architectures 100 for LTE WLAN aggregation (LWA), which can be standardized by the 3GPP RAN working group 2 and 3 in the forthcoming 13th release of the 3GPP standardization.

The network architecture 100 can comprise an end-to-end network for cellular communications, including a UE 110, an eNB 120, and the following two gateway entities of an evolved packet core (EPC): a serving gateway (S-GW) 130 and a packet data network (PDN) gateway (PDN GW, or P-GW) 140. One of ordinary skill in the art will recognize that an EPC typically includes other network entities and interfaces not further detailed such as, for example, the connections to the internet 192, or 194.

The UE 110 communicates with the eNB 120 through an air interface Uu 150 (also referred to as a cellular link), which can comprise a wireless radio communication channel defined in 3GPP standards for long term evolution (LTE) wireless networks. The UE 110 can also operate as a dual connected device or dual radio UE 110 by being communicatively coupled to a WiFi interface 196 or one or more other communication links/interfaces on the network concurrently or at the same time.

The S-GW 130, in communication with the eNB 120 through an S1 interface 160, provides a point of interconnect between the wireless radio side and the EPC side of the network architecture 100, as a co-located/non-collocated eNB, in which “collocated” refers to the LTE AP (e.g., the eNB) being located in the same network device or component. Network devices herein can be a gateway support node device, a cellular management entity device, a packet data gateway device, an eNB, for example, as well as other network devices functionally serving network communications for UEs and combinations of these devices communicatively coupled to one another.

The S-GW 130 can comprise the anchor point for the intra-LTE mobility, i.e., in case of a handover between eNBs and between LTE and other 3GPP accesses. The S-GW 130 is logically connected to the other gateway, the P-GW 140, through an S5/8 interface 170. 3GPP standards specify separately the S-GW 130 and the P-GW 140, but in practice, these gateways can be combined as a common network component provided by a network equipment vendor. The P-GW 140 further provides a point of interconnect between the EPC and an external internet protocol (IP) network (not shown). An external IP network is also called a packet data network (PDN). The P-GW 140 can route IP packets to and from PDNs.

In addition to the aforementioned end-to-end cellular network components, FIG. 1 further illustrates that the UE 110 communicates with the eNB 120 through a WLAN 180 via a Yy interface 190, and can be connected to both the WLAN 180 and the eNB 120 concurrently or simultaneously via interfaces 196 and 150, respectively. The Yy interface 190 represents the operative network connection and protocols between the UE 110 and its associated cellular base station (BS), the eNB 120. In other words, the Yy interface 190 is a logical interface that can be realized by a WLAN point-to-point communication link between the UE 110 and the eNB 120 for routing the UE 110's cellular traffic via the WLAN 180. For this reason, the terms “Yy interface” and “WLAN point-to-point communication link” are for the most part used interchangeably.

The WLAN point-to-point communication link 190 can comprise either a single link identified by the UE's media access control (MAC) address or other unique identifier, or several links with each link corresponding to a data radio bearer (DRB) of the UE. In addition, the LTE eNB 120 and the WLAN 180 can communicate on an Xw link 198 (e.g., an X_{2 l}ink), or Xw interface over user plane protocol or a control plane protocol. The user plane protocol can comprise a general packet radio service tunneling protocol for a user plane (GTP-U) with the eNB 120 and the control plane protocol can comprise an Xw application (Xw-AP) protocol, for example.

In the 3GPP terminology, a bearer represents a class of traffic having a set of network parameters that establish a specific standard treatment for the traffic or data being communicated on the particular class of traffic (e.g., voice or the like) for one or more UEs or network devices (e.g., eNBs or the like). Bearers carry user plane traffic (i.e., user data) on an air interface, which can be considered bearer traffic or traffic data.

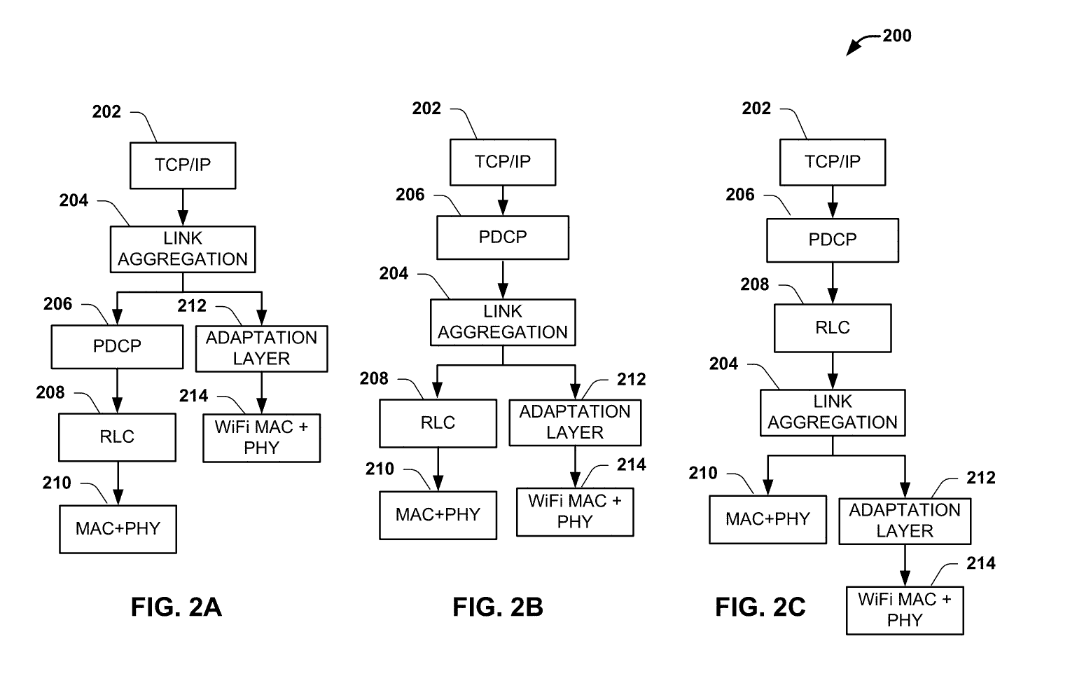

In one aspect, different protocol aggregations can be utilized for splitting data traffic on a network from LTE traffic and further routed over the WLAN 180. Different link aggregation architectures can be utilized with embodiments herein for splitting a 3GPP bearer to different communication links (e.g., WLAN, eNB or other communication links associated with different RATs). FIGS. 2A-2C illustrate various architectures 200 of protocol aggregation options applicable for RAN anchored WLAN networks. TCP/IP layer 202 comprises a Transmission Control Protocol/Internet Protocol layers that is the basic communication language or protocol of the Internet, and can be used as a communications protocol in a private network (either an intranet or an extranet). The TCP/IP layer 202 facilitates communications protocols used to connect network devices on the Internet.

The link aggregation layer 204 can be used to meet demand for faster data rates, by combining multiple channels at different frequencies and even different radio technologies or RATs according to embodiments herein. LTE, Wi-Fi and LTE using Wi-Fi spectrum, for example, can be aggregated. For example, using Wi-Fi for downlink and LTE mostly for uplink can be aggregated together, as well as other combinations of linking among different RATs that are either collocated or non-collocated. This can be done by routing traffic across both wireless interfaces and through a central anchor point (e.g., eNB) in the mobile core network (EPC). Traffic can be steered between both DL and UL modes. Initial studies indicate that moving the Wi-Fi uplink traffic to LTE can double the range and increase DL throughput (e.g., at least 20%), while cell edge performance can also be increased dramatically (e.g., more than 10 times).

The Packet Data Convergence Protocol (PDCP) layer 206, below or lower than the link aggregation layer 204, can be one of the layers of the Radio Traffic Stack in LTE, UMTS and performs IP header compression and decompression, transfer of user data and maintenance of sequence numbers for Radio Bearers which are configured for lossless serving radio network subsystem (SRNS) relocation.

The radio link control (RLC) layer 208, below or lower than the PDCP layer 206, can handle an automatic repeat request fragmentation protocol used over a wireless air interface. The RLC can detect packet losses and performs retransmissions to bring packet loss down to a low percentage rate, which is suitable for TCP/IP applications.

The physical(PHY) and media access control (MAC) layers 210 and 214, corresponding to separate RATs respectively, can operate to provide an electrical, mechanical, and procedural interface to the transmission medium. The physical layer translates logical communications requests from the data link layer into hardware-specific operations to affect transmission or reception of electronic signals. The MAC sublayer provides addressing and channel access control mechanisms that make it possible for several terminals or network nodes to communicate within a multiple access network that incorporates a shared medium.

The adaptation layer 212 can operate for a unified framework across all layers of the wireless protocol stack ranging from the physical layer to the application layer. The adaption layer 212 can provide adaptation in the data link layer, network layer, and application layer, for example. Adaptation can be utilized in order to achieve high capacity and ubiquitous communications across network devices. Adaptation can be dependent upon the state of the relevant parameters in all layers.

FIG. 2A illustrates an example layer architecture where link aggregation layer can be above the packet data convergence protocol (PDCP) layer 206 that provides a PDCP status report of a UE device via a long-term evolution (LTE) link (e.g., the Uu 150). In another example, FIGS. 2B-2C illustrates architectures in which the link aggregation layer 209 can occur above the RLC layer 208 and below a PDCP layer 206, as well as below the radio link control (RLC) layer 208.

Referring again to FIG. 1, the 3GPP interface can be used as the control and mobility anchor for the WLAN link (e.g., 190 or 196), which serves as an additional “carrier” within the 3GPP network and is used for data offload. 3GPP has agreed to a PDCP offload solution for WLAN aggregation, wherein PDCP packets are sent to the WLAN termination point, which, for example, could be an AP or an Access Controller-AP (e.g., AP 199) via the Xw interface (e.g., general packet radio service tunneling protocol user plane (GTP-U)).

In one aspect, the Xw 198 link can be a user plane or control plane protocol. The user plane protocol can be the GTP-U protocol and the control plane protocol can be the Xw-AP protocol. More specifically information can be exchanged via down link (DL)-Delivery-Status message or a PDCP status report on the user plane. In addition, the Xw 198 load information can be provided via on Xw AP plane, for example.

In another aspect, WLAN offload can be transparent to the WLAN AP (no AP impact), by sending above or below PDCP IP or PDCP data over an IP/IP-sec tunnel between the eNB 120 and the UE (e.g., 150). In another aspect, bearer traffic can be entirely offloaded to the WLAN 180 or the bearer can be split over both WLAN and LTE links 150 and 198, or 199, respectively for the WLAN 180 and eNB 120.

The advantages with splitting the bearer between WLAN 180 and eNB 120 comprises maximizing system performance (e.g., lowering delay times and increasing signal processing/power efficiency) to be able to efficiently split the traffic across these different RATs for each UE 110 of a plurality of UEs 110 coupled to the network environment 100. These processes can be based on minimizing or equalizing the relative transmission delays across multiple links in order to decrease transmission delays by efficiently determining splitting ratios for bearer traffic between different RATs (e.g., WLAN 180, LTE 120, as well as 5G mm-wave RAT, WiGiG, legacy 3GPP RATs, multi-link carrier and secondary cell aggregation within the same RAT, or other RATs). Although bearer splitting processes or schemes between WLAN and LTE are discussed in this disclosure, other types of RATs are also envisioned to be utilized in combination of different or similar RATs.

Different bearer splitting models or architectural configurations can be utilized as “push” and “pull” models of bearer splitting. The main operating principles of these architectures can work across both collocated and non-collocated WLAN deployments, across Uplink and Downlink bearer splitting, as well as can support various protocol aggregation solutions, in which the embodiments described herein are not limited to any particular one.

The devices or components disclosed can operate to split traffic across multiple radio access technology links and UEs. The splitting processes can be based on minimizing or equalizing the relative transmission delays across multiple links. The optimal solutions for the targeted metrics can lend themselves to iterative solutions, which rely on minimal exchange of information related to the state of the WLAN radio access technologies RATs, making them especially amenable to implementation with non-collocated WLAN/LTE deployments, in which the WLAN 180 and the eNB 120 are not within or adjacent to a same network device of a heterogeneous network.

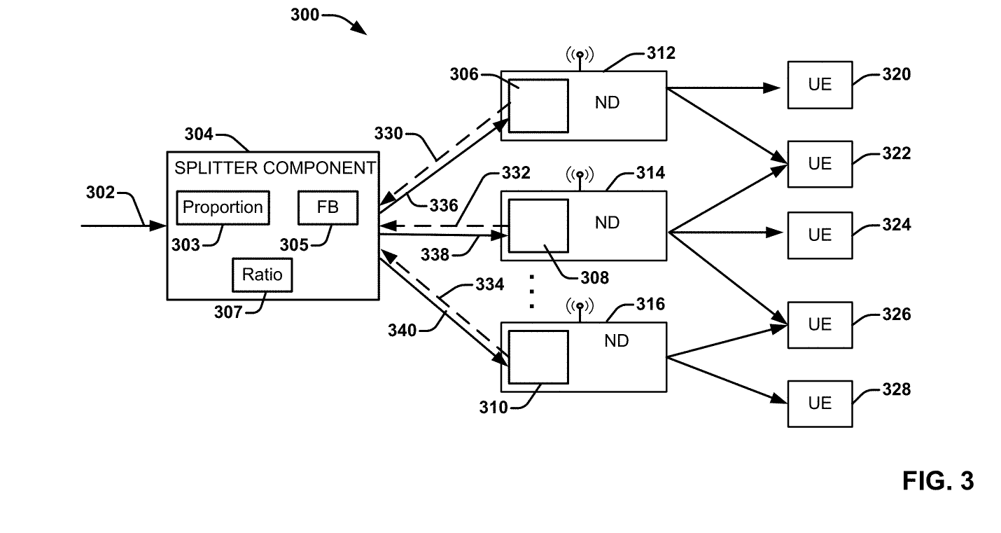

FIG. 3 illustrates one example network system 300 for traffic splitting and aggregation of data in accordance with various aspects across multiple RATs. The network environment 300 comprises a splitter component 304 (flow splitter/router/scheduler) that receives data from various different network devices as data traffic from one or more APs, eNBs, UEs, or other network devices or components of one or more different RATs. The splitter component 304 enables the network environment 300 to be delay aware according to various process schemes or sets of operations by dividing the traffic data, such as bearer traffic data among network devices 312-316, for example.

The network devices 312-316 can comprise one or more WLAN network devices, eNBs, small cell network devices, routers or other network device configured to communicate with various UEs 320-328 within one or more network zones for communication and managing operations therein. The network device 312, for example, can comprise a WLAN base station 312 with a WLAN base station queue 306 for buffering traffic thereat. The network device 314, for example, can comprise a router with a buffer or respective base station queue 308. Further, another network device 316 can comprise an eNB with a base station queue 310. Likewise, one or more additional or alternative base station RATs can be coupled to the splitter component 304 with traffic buffers or queues thereat for traffic flow.

Each UE 320-328 can be single or dual connected devices that are communicatively coupled to one or more communication links (e.g., license or unlicensed links) via one or more network devices or nodes (e.g., WLAN 312 and eNB 316, or any other RAT network device). The network system 300 can include any number of base stations/access points/RATs across which the traffic can be split for each UE 320-328. Various processes can be executed by the flow splitter component 304, which can be located or reside at the eNodeB (e.g., 316) in cellular networks.

In one aspect, the splitter component 304 can route different fractions or data amounts of traffic via one or more of the paths 332 across the connected base stations (BSs) 312-316 based on the feedback received from each of those BSs 312-316 via one or more feedback paths or interfaces 330. For example, for UE 322, the splitter component 304 can decide how much of a fraction of UE 322's traffic is sent through BS 1 (e.g., WLAN 312) and BS 2 (e.g., network access point 314). For example, the splitter component 304 comprises a proportion component 303 that can determine different ratios of a bearer (e.g., a 3GPP bearer) assigned to multiple communication links (e.g., links or interfaces 330-340) for UL or DL communication. The proportion component 303 determines amounts of a bearer to split and correspond to each communication link, including one or more parameters for traffic data flow in a link or data amounts of bearer traffic data corresponding to a plurality of communication links of the multi-radio heterogeneous network. The proportion component 303 determines the ratios between two or more links based on a set of heterogeneous network metrics, wherein the plurality of communication links comprise a 3GPP communication link and one or more other multi-radio links (e.g., WLAN or other RAT network devices) of the multi-radio heterogeneous network.

Accordingly, the splitter component 304 can generate splitting decisions dynamically based on real-time measurements, accounting for heterogeneous network metrics such as link network quality (e.g., QoS), congestion (e.g., load), propagation delays (e.g., measurement gaps or the like), and traffic requirements (e.g., Quality of Experience) for each UE 320-328 across LTE (e.g., BS 316) and WLAN (e.g., BS 312), as well as other heterogeneous network metrics dynamically defining the network conditions of the heterogeneous network. As the metrics change so can the bearer ratio by which the splitter component divides or splits the bearer among communication links for traffic data to flow accordingly there-through.

While the splitter component 304 and the network processes it performs are described in the context of LTE and WLAN aggregation, these processes and associated benefits are equally applicable for aggregation across other RATs as well as multiple links across the same RAT (e.g. 5G, mm-wave RAT, WiGiG, dual connectivity link across licensed and un-licensed band, multi-channel aggregation, and across more than one RAT, etc.), in which associated signaling modifications for the 3GPP LWA architectures and associated processes for bearer or bearer traffic can be enabled with and without WLAN AP impact.

In another aspect, the splitter component 304 can generate bearer splitting so that portions or fractions of the bearer data are concurrently or simultaneously communicated to different network devices (e.g., WLAN and LTE eNB, or the other RAT network devices) to minimize delay and support dual connectivity UEs (e.g., UE 322, 326). The signaling flow can be over Xw (eNB to WLAN Termination point) or the Uu (UE to eNB), for example, and optimized for minimizing or balancing time delays across the network communication links of a heterogeneous network on a per bearer basis. As such, each bearer can be designated or assigned with different splitting ratios dynamically based on the changing heterogeneous network metrics for each bearer.

For example, the proportion component 303 can operate optimal bearer split solutions based on delay-based objectives and develop iterative solutions to solve them. The following solution processes for determining the splitting ratios of a bearer and corresponding traffic data can be determined by the proportion component 303:
Minimizing the maximum average delay across multiple radio links (MMD);
Minimizing the sum of average delays across multiple radio links (MSD);
Delay equalization—minimizing the delay of a packet transmission for different interfaces of one UE; and
Rate equalization—offloading according to the individual UE interface rates that each UE experiences across the communication links (from among which its flow is split) in the network 300.

These processes generated by the splitter component 304 via the proportion component 303 dynamically obtain an optimal ratio of traffic data that can be split across multiple RATs for each user by solving a convex optimization problem or mathematical function via an iterative gradient descent approach. The processes dynamically tune the ratio of the bearer and traffic sent over each link for each user based on at least the following three key metrics:

(a) Queue utilization at each of the LTE base station and WLAN AP (Q);

(b) Physical/MAC layer data rates of UEs on the respective RATs (R); and

(c) eNB-WLAN backhaul delay (D).

In one embodiment, these above three metrics are either sent directly to the eNB (e.g., ND 316) from the respective APs (e.g., splitter 304) or sent by the UEs over the LTE link (e.g., network traffic link 302). Using the above three metrics, the processes for determining MMD/MSD, via the proportion component 303, can tune the fraction of traffic sent through each link (e.g., links 330-340). For example, an iterative process can be performed in order to determine any one of the processes, functions or operations with the heterogeneous network metrics (e.g., MMD, MSD, Delay Equalization, or Ratio Equalization). If ‘P’ denotes the fraction of traffic for a UE sent over an LTE link, then in the (k+1)th step/update P(k+1) is computed based on the previous splitting ratio P(k) and a function of the metrics received from the APs/UEs: P(k+1)=P(k)+a(Q,R,D), where ‘a’ denotes the specific function (e.g., MMD, MSD, Delay Equalization, or Ratio Equalization) used as a step size.

In another embodiment, the splitter component 304 or the eNB (e.g., eNB 316) on which the splitter component 304 resides can further comprise a specific feedback component (e.g., feedback component 305) that exchanges feedback information with a WLAN AP via an Xw interface over a user plane or control plane protocol. The user plane protocol can comprises a general packet radio service tunneling protocol user plane (GTP-U) protocol and the control plane protocol comprises an Xw application protocol (Xw-AP), for example. More specifically, information can be exchanged via a down link DL-Delivery-Status message on a user plane, and Xw load information or queue utilization can be sent on the Xw AP control plane.

In another embodiment, the splitter component 304 or the eNB (e.g., eNB 316) on which the splitter component 304 resides can further comprise a ratio update component 307 that can update one or more splitting ratios related to the different data amounts of bearer traffic data by iteratively increasing/decreasing a first portion of the bearer traffic data sent over an LTE link for a UE in response to a total weighted delay over a WiFi link being greater than over the LTE link. In addition, the ratio update component 307 can iteratively increase/decrease a second portion of bearer traffic data sent over the WiFi link for the UE in response to the total weighted delay over the LTE link being greater than over the LTE link.

Alternatively or additionally, the ratio update component 307 can also operate to increase the first portion with a first step size as function of a direct proportion to a PHY/MAC rate associated with the LTE link and an inverse proportion to an LTE base station (BS) utilization, and increase the second portion with a second step size as a function of another direct proportion to the PHY/MAC rate associated with the LTE link and another inverse proportion to a WiFi utilization.

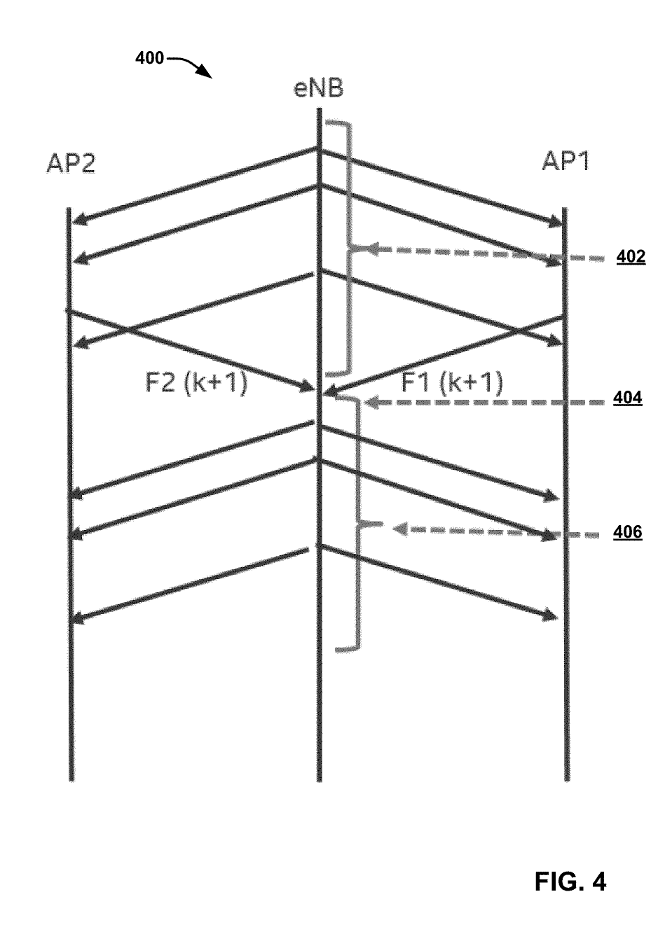

FIG. 4 illustrates an example of a protocol or process flow 400 for dividing the bearer traffic with two APs (AP1 and AP2) anchored at the eNB for traffic splitting among different UEs or users in a multi-radio heterogeneous network. The eNB splits traffic based on an initial splitting ratio P(k), in which k is the current time at 402. The process flow continues from the top of the time lines to the bottom with respect to time. At 404, feedback is being sent from the AP1 and AP2, or UEs (e.g., three different UEs associated to the three arrows illustrated) correspondingly connected thereto. At 406, the new traffic split P(k+1) is obtained using P(k) and feedback F1 and F2 via AP1 and AP2 respectively. The feedback thus is represented by F1 and F2, which are at time instance k+1. This feedback, for example, comprises the heterogeneous metrics discussed above comprising queue utilization (Q) at each AP1 and AP2 (e.g., buffer queues 306, 310 of the LTE base station 316 and WLAN AP 312), PHY/MAC layer data rates (R) of UEs on the respective RATs, and backhaul delay (D), comprising F1(k+1) and F2(k+1), wherein F1 and F2 represent feedback functions having the metrics with respect to time instance k+1.

Based on these functions with respect to k+1 being received with the new feedback with the heterogeneous network metrics, the eNB re-computes a different fraction P(k+1) for updating the splitting ratio(s) utilized for bearer splitting between the access points. For example, as discussed above, ‘P’ denotes the fraction of traffic for a UE sent over a LTE link to ND 316, then in the (k+1)th step/update P(k+1) is computed based on the previous splitting ratio P(k) and a function of the metrics received from the APs/UEs: P(k+1)=P(k)+a(Q,R,D), where ‘a’ denotes the specific function (e.g., MMD, MSD, Delay Equalization, or Ratio Equalization) used as a step size for the new updated splitting ratios for dividing a bearer for associated traffic.

As one advantage, the process flow 400, for example, via the splitter component 304 operates to minimize the maximum or sum delay for a normal UE, and thus provide better performance as compared to a “no splitting” protocol, a switching bearer protocol, and other fixed ratio traffic splitting protocols.

In simulation examples, a proposed MMD (where ‘a’=the MMD process) can be compared to that from a WiFi preferred (WP) scheme. In a WP scheme, for example, a UE switches to using WiFi when the SNR on WiFi is above a threshold (e.g., 10 dB), whereas in the proposed schemes or processes (e.g., MMD, MSD, Delay Equalization, or Ratio Equalization) the user traffic is split across two different RATs (e.g., LTE eNB and WLAN or another RAT) in appropriate fractions. For this particular simulation example, a network setting or environment can consists of about five WiFi APs and thirty UEs uniformly distributed per LTE macro cell area or eNB network zone, for example. The delay on the WiFi backhaul is assumed to be 20 milliseconds (ms). Each UE or user's traffic of the thirty connected UEs can be modeled as a Poisson arrival process with file size of 1 MB and inter arrival time of 2.5 s. As such, the proposed MMD scheme leads to about 70-80% increase in both the edge and median rate over the reference scheme, providing clear advantages of flow splitting based on the proposed approach. All of the various splitting processes that can be performed by the splitter component 304 can provide similar advantages as well (e.g., MSD, Delay Equalization, and Ratio Equalization).

Referring back to FIG. 3, the example network system 300 can have any number of b base stations/access points/RATs (e.g., NDs 312-316) across which the traffic can be split for each user UE 320-328. The splitter component 304 can execute splitting operations or processes and can reside at an eNodeB in cellular networks (e.g., co-located/non-collocated with eNB 316 or other ND). The splitter component 304 routes different fractions of traffic data across the connected base stations (BSs) (e.g., NDs 312-316) based on the feedback received from those BSs.

For example, for UE 322, the proportion component 303 of the splitter component 304 decides how much fraction of UE traffic is communicates through two or more base stations or APs (e.g., NDs 312 and 314). For simplicity, the processes (e.g., MMD, MSD, Delay Equalization, or Ratio Equalization) are described in more detail for a single macrocell network with link aggregation done over two BSs or APs. However the one of ordinary skill in the art can be extended to additional BSs or APs coupled to any number of UEs.

In an embodiment, an LTE Macrocell (e.g., eNB 316) can be denoted by BS 0. For BS 1 . . . BS b, b APs can be overlaid within BS 0, in which b is any integer greater than zero. A user UE can be located at ‘x’ as denoted by ‘x’, and ‘x’ can associate with BS0 and one other AP (1 . . . b) simultaneously for a dual connectivity. UE ‘x’ can belong to the coverage region C(j)_{j=1 . . . b} of the one other AP (based on e.g. SNR). The reference p(x) denotes the fraction of flow of x carried on BS 0. Hence 1−p(x) can be the fraction of flow of x routed to AP j, when x is in the coverage region C(j). Thus p(x)=0 can be the situation where all traffic for x is on or covered by WiFi; and p(x)=1 can be the situation where all traffic for x is on LTE.

The arrival rate at user ‘x’ can be denoted by λ(x) (e.g. flows/files per seconds). Total arrival rate in the cell (file/second) can be represented by Λ=λΣ(x). The total arrival rate at BS i (b) is denoted by Λi. Corresponding mean file size can be represented by 1/μ(x) (e.g. Mb). Traffic load density for user x can be represented by: γ(x)=λ(x)/μ(x) (Mb/s). PHY rate of user x with BS i, can be represented by Ri(x) (e.g. Mb/s). System load density for UE x can be represented by ξᵢ(x)=γ(x)/Rᵢ(x) (<=1); i.e., the fraction of time required to deliver traffic load γ(x) from BS i to x.

Given the above notations, the average delay on a network route through BS i can be represented by: Ti=Queuing delay+Backhaul delay, wherein

$$Queuing delay = \frac{1 ( Qi )}{Λ i ( 1 - Qi )} ;$$

where Qi are the respective queue utilizations.

Queue utilizations can comprise a queue length or a factor of time (e.g., an average proportion of time) that a particular buffer or queue is utilized or occupied at a respective ND or AP buffer (e.g., 306-310). The backhaul delay can be represented as dᵢ. The maximum (across the BSs, e.g., two dual connected BSs) of average delay can be represented by

$$Tmax = {max}_{i = 0 … b} \frac{Λ i}{Λ} Ti .$$

The sum of the average delay can be represented by:

$$Tsum = {sum}_{i = 0 … b} \frac{Λ i}{Λ} Ti .$$

Under the above notations, the various processes (e.g., MMD, MSD, Delay Equalization, or Ratio Equalization) can be minimized with subsequent processes described below.

Various problem formulations (PF) enable the objectives of minimizing time delay across the network by bearer splitting. A sum of average delay across different paths for a new arrival into a network (MSD) can be expressed as follows:

$$PF 1 \text{:} {min}_{P} \{ U ( P ) = {\sum }_{i = 0}^{b} \frac{{ρ}_{i} ( P )}{1 - {ρ}_{i} ( P )} + {Λ}_{i} ( P ) {d}_{i} \} ;$$

A maximum of average delay across different paths for a new arrival into the network (MMD) can be expressed as follows:

$$PF 2 \text{:} {min}_{P} \{ U ( P ) = {min}_{i = 0 … b} \{ \frac{{ρ}_{i} ( P )}{1 - {ρ}_{i} ( P )} + {Λ}_{i} ( P ) {d}_{i} \} \} ,$$

wherein 0≤P≤1; and ρ₀(P)=Σₓξ₀(x)P(x), ρᵢ(P)=Σₓ1(x∈C(i))ξᵢ(x)(1−P(x)), i≈0; and Λ₀(P)=Σₓλ₀(x)P(x), λᵢ(P)=Σₓ1(x∈C(i))λᵢ(x)(1−P(x)), i≈0.

Because the objectives and formulations above for the processes (e.g., MMD, MSD, Delay Equalization, or Ratio Equalization) generated by the splitter component 304 are convex in splitting ratios, the optimization of these process can be done via gradient descent processes. Algorithms based on gradient descent to achieve the optimal solution for bearer splitting via the splitter component 304 are described in more detail for each solution function ‘a’ (e.g., MMD, MSD, Delay Equalization, or Ratio Equalization) below.

In an embodiment, for both these solution processes the initial value (P0) of splitting ratios could be based on past history for a corresponding UE, such as the history of heterogeneous network metrics, the history of bearer splitting with respect to network performances (e.g., User Experience), or the like. In another example, the initial value (P0) could be based on the PHY rate or MAC rate estimates on respective links of the network, in which the split portions of the bearer could be based on a change in these rates, either directly or inversely related, for example. Alternatively or additionally, the splitting ratio of the bearer over different network device RATs in a dual connected UE could be some default value; such as 1:1 ratio could be predetermined and defaulted to initially by the splitter component 304, for example.

While the methods described within this disclosure are illustrated in and described herein as a series of acts or events, it will be appreciated that the illustrated ordering of such acts or events are not to be interpreted in a limiting sense. For example, some acts may occur in different orders and/or concurrently with other acts or events apart from those illustrated and/or described herein. In addition, not all illustrated acts may be required to implement one or more aspects or embodiments of the description herein. Further, one or more of the acts depicted herein may be carried out in one or more separate acts and/or phases.

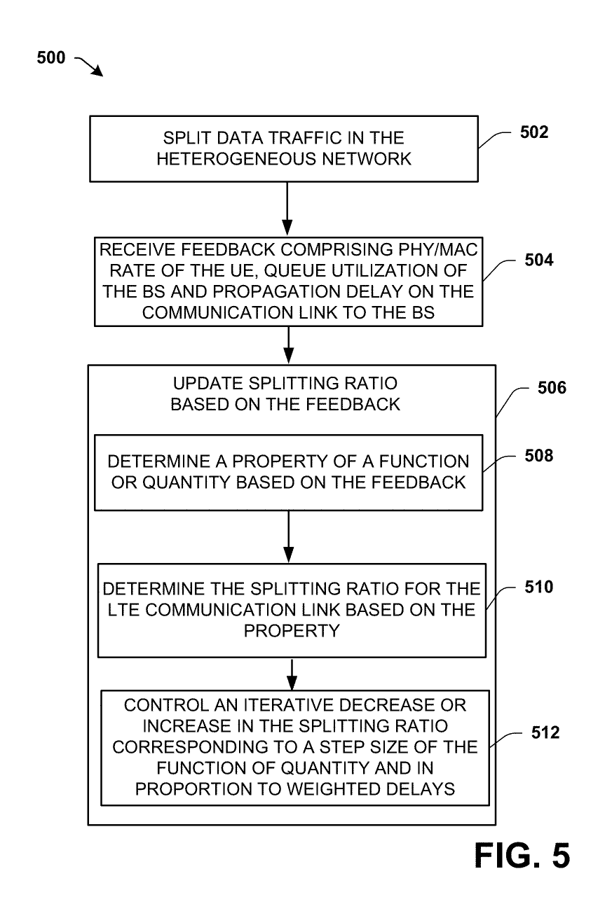

FIG. 5 illustrates one embodiment of a process flow 500 that can be selected by the splitter component 304. The method 500 can be considered a Minimize Sum Average Delay (MSD) process, for example, which solves the problem formulation PF1 by minimizing the sum of average delays for the UEs connected across different radio links (e.g., WLAN, LTE, or other RAT), such as with dual connectivity or two different network communication links operating concurrently with a UE (e.g., UE 322).

At 502, the splitter component 304 can split data traffic in a heterogeneous network. For example, the splitter component 304 can split traffic (communication or traffic data) based on a current splitting ratio for each UE (e.g., 320-328).

At 504, feedback is received at the splitter component 304 that comprises a PHY rate or MAC rate of the UE (e.g., 322 or other UE), queue utilization of the BS (e.g., 312-316) and a propagation delay on the communication link to the BS. In other words, the splitter component 304 uses the most recent feedback from BS i on a MAC or a PHY rate Ri(x) (of UE x), queue utilization at BS i Qi, and the propagation (backhaul) delay on the link to BS i Di to update the splitting ratio.

At 506, an updating can be performed dynamically based on changes being detected in the heterogeneous network metrics, as well as in an iterative process flow according to a steps size increase or decrease, and a selection of one of the delay minimizations processes (e.g., MMD, MSD, Delay Equalization, or Ratio Equalization). The process flow 500 continues in response to the MSD process.

At 508, the splitter component 304 can determine a property of a function or quantity based on the feedback. For example, for UE x, the splitter component 304 can determine the sign of the quantity/function: ξ0(x)/(1−Qo)−ξi(x)/(1−Qi)+λ(x)(D0−Di).

At 510, the splitter component 304 can determine the splitting ratio for the LTE communication link based on the property (e.g., the sign of the quantity). For example, if the sign is positive, new splitting ratio for LTE link can be represented as P(x)=P(x)−a0(Q,R,D) where a0(Q,R,D) can be a small step size. In addition, if the sign is negative, new splitting ratio for LTE link can be represented as P(x)=P(x)+a1(Q,R,D) where a1(Q,R,D) is a small step size.

At 512, the splitter component 304 can then control an iterative decrease or increase in the splitting ratio corresponding to a step size of the function of quantity and in proportion to weight delays. The step sizes a0 and a1 can be used to govern the iterative decrease and increase in the ratio for LTE link and can be selected in proportion of the corresponding weighted delays, represented as: a0(Q,R,D)=1/R0*(1−Q0)̂2/[1/R0*(1−Q0)̂2+1/R1*(1−Q1)̂2)]; and a1(Q,R,D)=1/R1*(1−Q1)̂2/[1/R0*(1−Q0)̂2+1/R1*(1−Q1)̂2)]. The processes can continued to iterated and repeated based on changing network conditions in order to minimize the network delay by updating the splitting ratios for splitting the bearer across multiple communication links of different RATs.

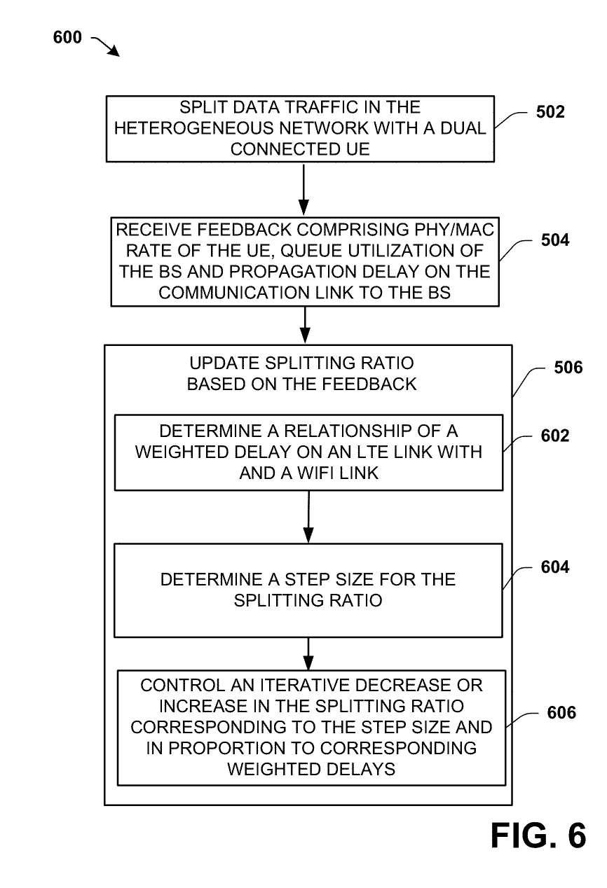

FIG. 6 illustrates another example process flow 600 that corresponds to the minimize maximum delay (MMD) processes for solving performance formulation 2 by minimizing the maximum delays for UEs connected across different BSs. The process flows similarly as acts 502-506 of FIG. 5 described above. At 506, however, the MMD process flow can be selected by the splitter component 304, for example.

At 602, a relationship is determined between a weighted delay on an LTE link and an WiFi link on the network as each correspond to a particular dual connected UE, for example. For example, the splitter component 304 can operate to increase the first portion with a first step size as function of a direct proportion to a throughput rate associated with the LTE link. The splitter component 304 can further increase the second portion with a second step size as a function of another direct proportion to the PHY/MAC rate associated with the LTE link also in relation to the PHY/MAC rate of the WiFi link or interface.

At 604, a step size can be configured or determined for the iterative process of updating a splitting ratio for the bearer and traffic data in a dual connected UE. For example, for UE x if weighted delay Qi/(1−Qi)+ΛDi is greater on LTE than that on WiFi then a new splitting ratio for LTE link is P(x)=P(x)−a0(Q,R,D) where a0(Q,R,D) can be a small step size. Additionally, for UE x if weighted delay Qi/(1−Qi)+ΛDi is greater on WiFi than that on LTE then new splitting ratio for LTE link is P(x)=P(x)+a1(Q,R,D), where a1(Q,R,D) is a small step size.

At 606, the splitter component 304 can control an iterative decrease or increase in the splitting ratio corresponding to the step size and in proportion to corresponding weighted delays. For example, the step sizes a0 and a1 can be used to govern the iterative decrease and increase in the ratio for the LTE link and are chosen in proportion of the corresponding weighted delays as follows: a0(Q,R,D)=1/R0*(1−Q0)̂2/[1/R0*(1−Q0)̂2+1/R1*(1−Q1)̂2)]; and a1(Q,R,D)=1/R1*(1−Q1)̂2/[1/R0*(1−Q0)̂2+1/R1*(1−Q1)̂2)]. A compliment or difference of the data/bearer can then be allocated to the other connected communication link, as is the case also for all the processes. The above process flows can be repeated for all UEs throughout the simulation.

In another embodiment, the splitter component 304 can simplify the MMD or MSD operations by utilized intelligent heuristic processes via rate equalization processes or delay equalization processes. The splitter component 304, for example, can select a process for minimizing time delay by determining bearer splitting ratios via a rate equalization process.

For example, the splitter component 304 can utilize a rate equalization to split the traffic in the ratio of the estimated throughput on LTE/WiFi interfaces. As such, the eNodeB and WiFi interfaces at corresponding BSs are estimating/measuring effective throughput of the communication link for each user UE. Then the splitter component 304 or BS can send the data to the splitter component 304 for the proportion component 303 (as a decision unit) to determine on the eNB. Thus, when a new packet arrives, the eNB, for example, then splits the data according to the following equality:

$$\frac{P}{{R}_{1}} = \frac{( 1 - P )}{{R}_{2}} ;$$

where H7 and R2 can be the user throughputs on the LTE and

WiFi interfaces respectively and P can be the fraction of traffic sent through LTE. Throughput and PHY rate can be different from one another. The PHY rate, for example represents what the maximum throughput a UE can get or observe if it is the only device connected on the particular communication link in question to a corresponding BS, as if using the entire bandwidth available. Throughput represents the actual flow rate or bandwidth rate being observed on the communication link.

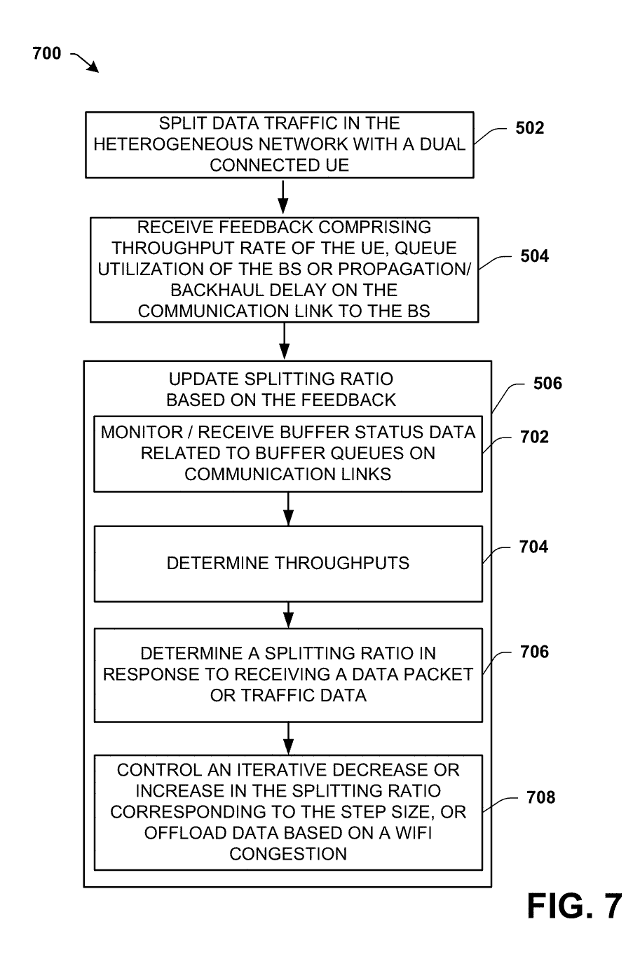

FIG. 7 illustrates an example process flow or method 700 in another embodiment where performance of the network devices (NDs) and communications can be further improved by incorporating buffer status information such as related to the queues (e.g., 306-310) via a delay equalization process flow.

The delay equalization method 700, for example, makes use of buffer information from the different communication links or interfaces by which a dual connected UE is communicatively coupled, such as LTE and WiFi interfaces, for example in order to equalize a buffer drain rate.

The processes 502-506 can be similar as described above with reference to FIGS. 5-6. At 702, the information about a current buffer status (amount of data queued on the interface) can be periodically reported to the eNB (e.g., 316) with the splitter component 304, or the splitter component 304 separately (non-collocated), for example, from the WiFi interface. The splitter component 304 or the eNB can also monitor its own LTE buffer status in a similar manner.

At 704, based on the received information, throughput on the interface could be also calculated based on the buffer drain speed and/or directly reported by the LTE/WiFi interface together with the buffer status.

At 706, when the new packet arrives, the primary eNB/splitter component 304 can perform splitting by calculating the offloading or splitting ratio P=(0..1), which stands for the percent % of data to be offloaded to LTE (1−P for WiFi) based on the following equation:

$$\frac{{B}_{1} + P * S}{{R}_{1}} = \frac{{B}_{2} + ( 1 - P ) * S}{{R}_{2}} ;$$

where B1 and B2 can represent current data in respective buffers/queues of LTE and WiFi interfaces respectively, R1 and R2 are the corresponding throughputs on the interfaces (communication links) and S is the size of the packet to offload.

For example, the splitter component 304 can operate to increase the first portion with a first step size as function of a direct proportion to a throughput rate associated with the LTE link and an inverse proportion to an LTE base station (BS) utilization. The splitter component 304 can further increase the second portion with a second step size as a function of another direct proportion to the throughput rate associated with the LTE link and another inverse proportion to a WiFi utilization.

At 708, the splitter component 304 can control an iterative decrease or increase in the splitting ratio corresponding to the step size, or offload data based on a WiFi congestion. New data can be collected based on the information received from the interfaces. If the WiFi interface is currently congested (e.g., satisfying a congestion level or predetermined threshold, or not able to queues any new traffic data or packet data), the splitter component 304 or eNB could dynamically respond by offloading the new packet to the LTE even if the link seems to have poor estimated throughput.

In another embodiment, the splitter component 304 can further generate some fragmentation to be applied to the packet (instead of transmitting the whole packet) if congestion occurs in order to have some feedback from the interfaces to tune the offloading splitting ratio more precisely).

The heterogeneous network metrics used in the process flows according to embodiments and descriptions related to FIGS. 5-7, namely BS queue utilizations, UE specific PHY rates on the respective BSs, and the propagation delays could be either estimated and/or received from feedback by either BSs or communicatively coupled UEs to the BSs. The LTE BS (e.g., eNB 316) already has the PHY rate estimate for its UEs based on the CSI/CQI feedback, for example, which can be sent to the eNodeB by the respective UEs. Requiring the WiFi AP to feedback the corresponding metrics, however, would require an upgrade on the AP. Alternatively, the metrics related to WiFi can be sent to splitter by the UE itself via the LTE uplink.

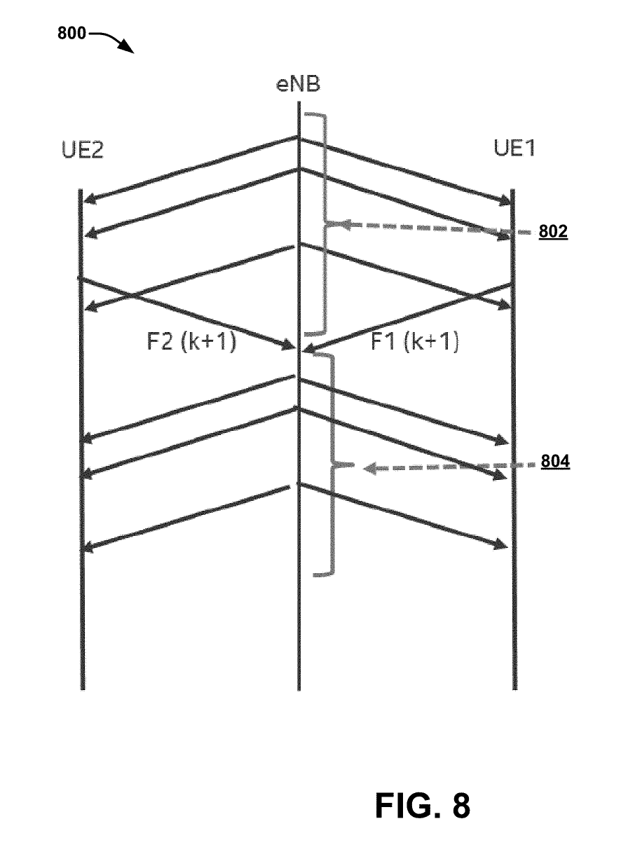

Referring to FIG. 8, illustrated is a process flow 800 that demonstrates the network processes without WLAN AP impact (e.g., a WLAN upgrade), where the UEs feedback the relevant metrics for the WiFi link in order for the process solutions described above related to FIGS. 5-7 and related embodiments to be implemented.

At 802, the traffic from UE1 and UE 2 are split based on a current splitting ratio P(k), which can be initially defaulted similarly to that described with reference to FIG. 4. The new traffic is then split with a new ratio P(k+1) that is based on a newly updated or iteratively stepped (incremented or decremented for each communication link) ratio. The new ratio P(k+1) at time instance k+1 is determined based on the feedback F1 and F2 from the different UEs.

At 804, the traffic is then split based on the new splitting ratio P(k+1).

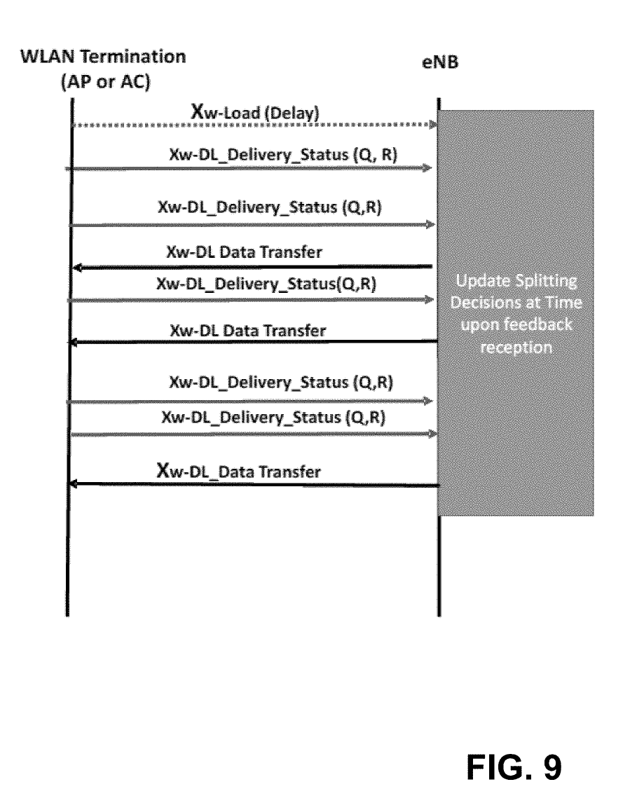

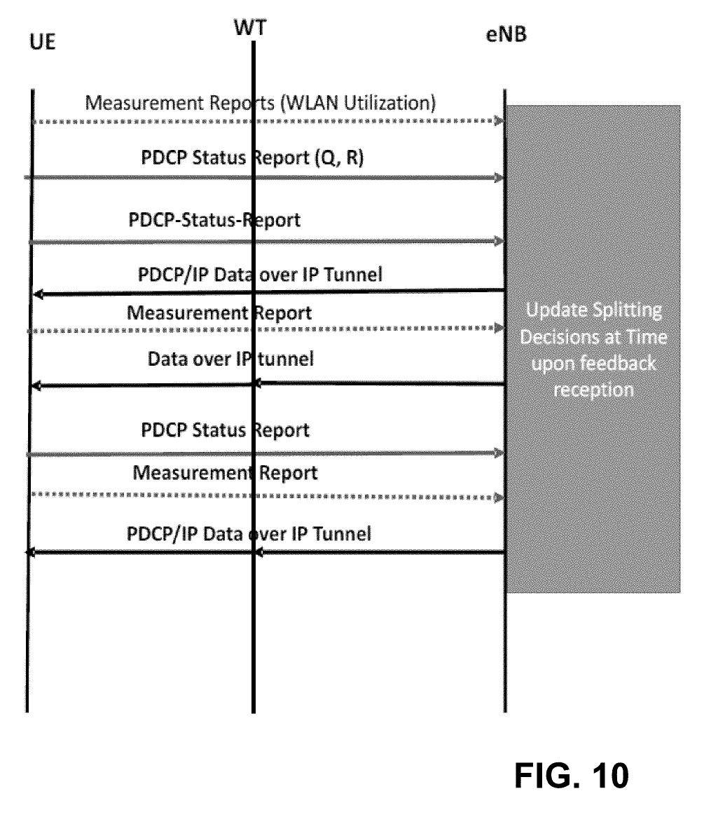

FIGS. 9-10 illustrate call process flows between the eNB and the WiFi termination point (e.g., WLAN AP or access controller (AC)). FIG. 9 provides the Xw interface carries the information of load (e.g., delay amount) to the eNB. The WLAN point or AP can then provide a status report as an Xw-DL_Delivery_Status (Q, R). This can be done on Xw interface or downlink channel shared between the two as a status message having the PHY/MAC data rate (R) or the queue utilization metric (Q), which can be sent for each UE respectively or in separate reports. Then the eNB will update the splitting ratio and decisions for offloading concurrently traffic data at the time upon each feedback reception from the WLAN.

The eNB (e.g., eNB 316) can further comprise a specific feedback component (e.g., feedback component 305) that exchanges feedback information with a WLAN AP via an Xw interface over a user plane or control plane protocol. The user plane protocol can comprises a general packet radio service tunneling protocol user plane (GTP-U) protocol and the control plane protocol comprises an Xw application protocol (Xw-AP), for example. More specifically, information can be exchanged via a down link DL-Delivery-Status message on a user plane, and Xw load information or queue utilization can be sent on the Xw AP control plane.

FIG. 10 illustrates process flows for exchanging of the feedback information between the eNB and the UE on the Uu control link. For example, the feedback component 305 (or eNB) can receive the set of heterogeneous network metrics from UE feedback information. The feedback component receives the UE feedback information based on extensions of a packet data convergence protocol (PDCP) status report of a UE device via a long-term evolution (LTE) link (e.g., the Uu control link), which can carry the delay or load information as well as other metrics. The eNB updates the splitting ratio or ratio decisions at a time of receiving the feedback. The WLAN or WLAN termination (WL) receives data over an IP tunnel and can forward the data to the UE in DL. The process can continue iteratively and dynamically based on network changing conditions for example at teach network device (e.g., WLAN, eNB or other ND).

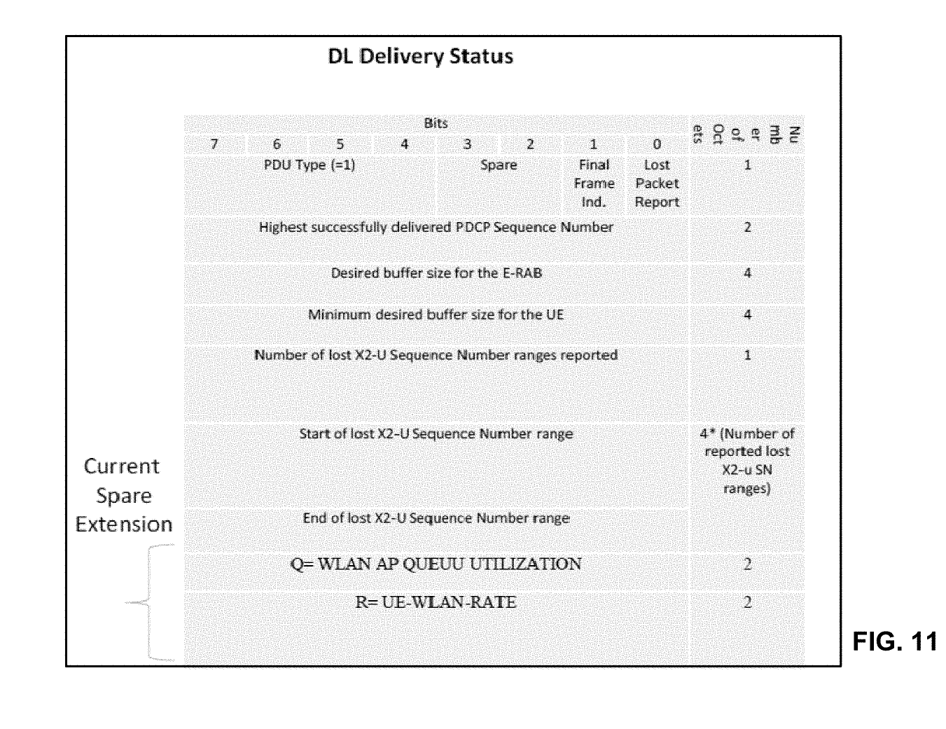

FIG. 11 illustrates example modifications to support the feedback information in the Xw-Delivery-Status information. Other extensions such as different sizes for the feedback information, etc. can also be supported. Similarly a procedure or process flow can be added to estimate the feedback delay over the X2 (e.g., Xw) link (exchange of control packets with time stamps or an ACK/NACK protocol to estimate round-trip-delay, or the like). This information can be exchanged via Xw-Load messages and does not need to be reported as frequently as the feedback on queue states and user data rates.

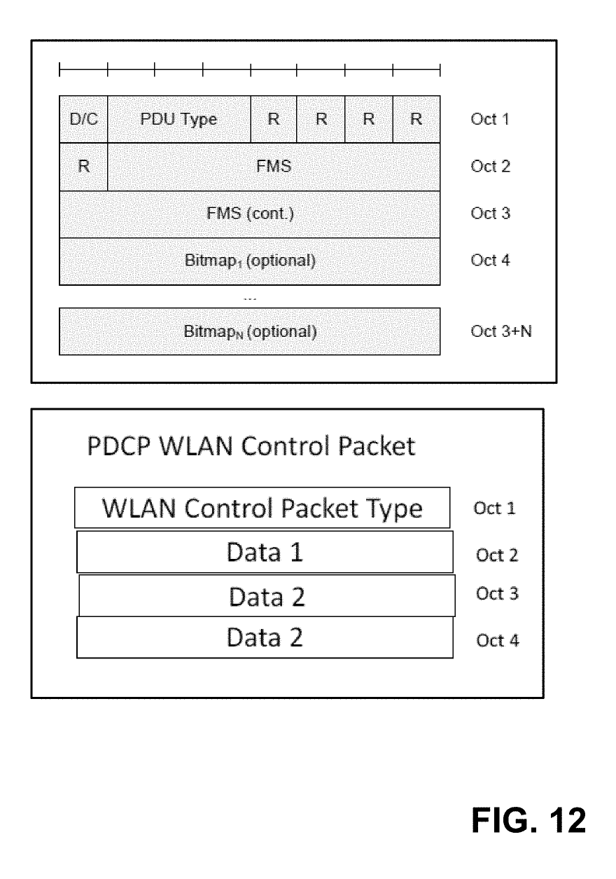

FIG. 12 illustrates modifications to the PDCP status report to include UE feedback on WLAN related measurements. The proposed feedback information elements may be carried via similar framework within the PDCP status report, for example. Here too, additional formats can be easily supported. For example the PDCP status report can directly be extended to include the feedback information. The PDU type packet can be set to PDU TYPE=WLAN Control packet and the WLAN control packet type indicates WLAN feedback packet, with the feedback information.

In other embodiments, other extensions can also be envisioned. For example, several other extensions to the proposed framework can be envisioned. For example the embodiments herein can have applicability to bearer split at the UE for uplink, aggregation across multi-radio device-to-device (D2D) (or UE to UE) communications as well as aggregation across multiple links across network devices. There can be further applicability to aggregation across other RATs (e.g. 5G mm-wave RAT, WiGiG, legacy 3GPP RATs, multi-link carrier and secondary cell aggregation within the same RAT, etc.).

Additionally or alternatively, the signaling protocol modifications can be in the context of existing 3GPP protocols used to support dual connectivity (i.e. GTP-U and X2AP, and PDCP status reports), but similar information can also be carried over alternate protocols as well.

Additionally or alternatively, other heterogeneous network metrics can be utilized, such as balancing of delays across multiple links. Example embodiments to achieve such balancing can include a) trying to equalize both the buffering and the air time delays across both communication links communicatively coupled to a UE, for example, and b) splitting traffic across links relative to the relative rate ratios across both links. Feedback information related to per bearer queues as well as transmission rates per UE can be used to support such schemes, for example. The feedback here can also be easily supported within the signaling framework demonstrated and discussed herein.

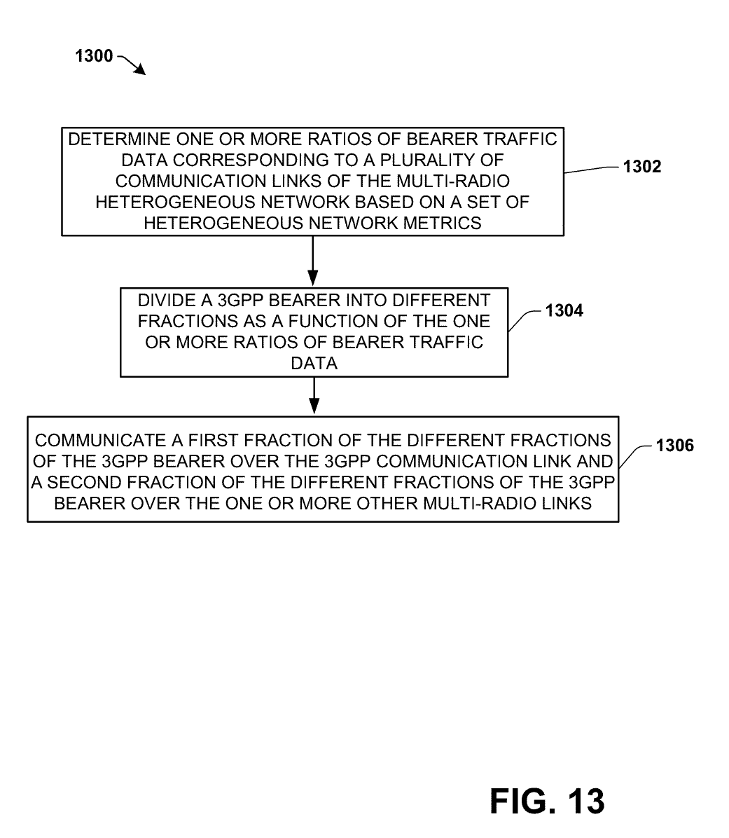

FIG. 13 illustrates another example process flow or method 1300 for bearer splitting in a multi-radio heterogeneous network of a radio access network (RAN). At 1302, the method comprises determining, via the one or more processors, one or more ratios of bearer traffic data corresponding to a plurality of communication links of the multi-radio heterogeneous network based on a set of heterogeneous network metrics, wherein the plurality of communication links comprise a 3GPP communication link and one or more other multi-radio links of the multi-radio heterogeneous network operating in a different protocol than the 3GPP communication link.

At 1304, the method includes dividing, via the one or more processors, a 3GPP bearer into different fractions as a function of the one or more ratios of bearer traffic data.

At 1306, the one or more processors communicate a first fraction of the different fractions of the 3GPP bearer over the 3GPP communication link and a second fraction of the different fractions of the 3GPP bearer over the one or more other multi-radio links.

As used herein, the term “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. In some embodiments, the circuitry may be implemented in, or functions associated with the circuitry may be implemented by, one or more software or firmware modules. In some embodiments, circuitry may include logic, at least partially operable in hardware.

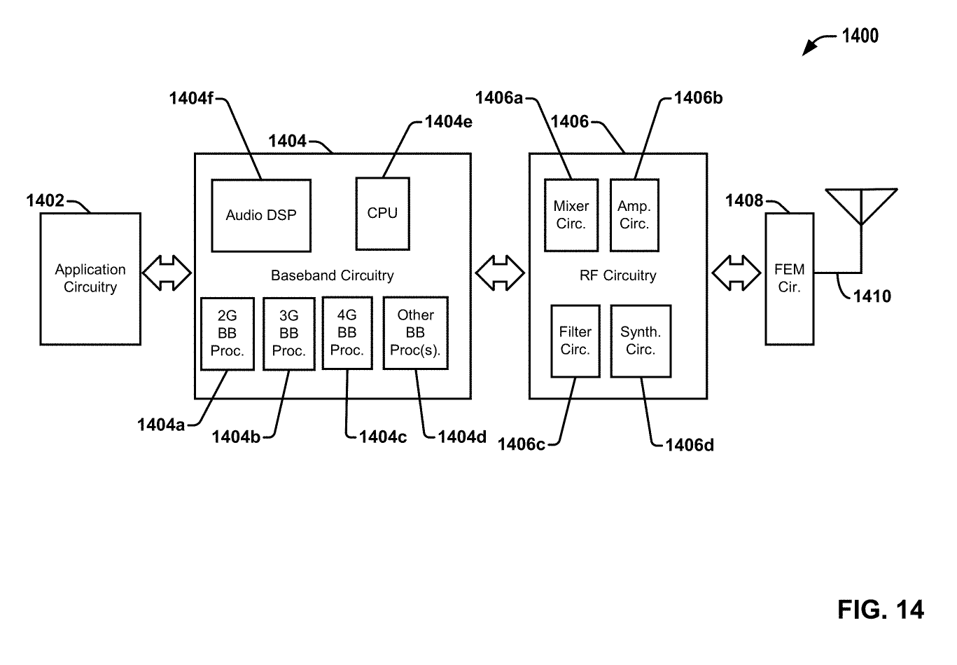

Embodiments described herein may be implemented into a system using any suitably configured hardware and/or software. FIG. 14 illustrates, for one embodiment, example components of a User Equipment (UE) device 1400. In some embodiments, the UE device 1400 may include application circuitry 1402, baseband circuitry 1404, Radio Frequency (RF) circuitry 1406, front-end module (FEM) circuitry 1408 and one or more antennas 1410, coupled together at least as shown.

The application circuitry 1402 may include one or more application processors. For example, the application circuitry 1402 may include circuitry such as, but not limited to, one or more single-core or multi-core processors. The processor(s) may include any combination of general-purpose processors and dedicated processors (e.g., graphics processors, application processors, etc.). The processors may be coupled with and/or may include memory/storage and may be configured to execute instructions stored in the memory/storage to enable various applications and/or operating systems to run on the system.

The baseband circuitry 1404 may include circuitry such as, but not limited to, one or more single-core or multi-core processors. The baseband circuitry 1404 may include one or more baseband processors and/or control logic to process baseband signals received from a receive signal path of the RF circuitry 1406 and to generate baseband signals for a transmit signal path of the RF circuitry 1406. Baseband processing circuity 1404 may interface with the application circuitry 1402 for generation and processing of the baseband signals and for controlling operations of the RF circuitry 1406. For example, in some embodiments, the baseband circuitry 1404 may include a second generation (2G) baseband processor 1404a, third generation (3G) baseband processor 1404b, fourth generation (4G) baseband processor 1404c, and/or other baseband processor(s) 1404d for other existing generations, generations in development or to be developed in the future (e.g., fifth generation (5G), 6G, etc.). The baseband circuitry 1404 (e.g., one or more of baseband processors 1404a-d) may handle various radio control functions that enable communication with one or more radio networks via the RF circuitry 1406. The radio control functions may include, but are not limited to, signal modulation/demodulation, encoding/decoding, radio frequency shifting, etc. In some embodiments, modulation/demodulation circuitry of the baseband circuitry 1404 may include Fast-Fourier Transform (FFT), precoding, and/or constellation mapping/demapping functionality. In some embodiments, encoding/decoding circuitry of the baseband circuitry 1404 may include convolution, tail-biting convolution, turbo, Viterbi, and/or Low Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 1404 may include elements of a protocol stack such as, for example, elements of an evolved universal terrestrial radio access network (EUTRAN) protocol including, for example, physical(PHY), media access control (MAC), radio link control (RLC), packet data convergence protocol (PDCP), and/or radio resource control (RRC) elements. A central processing unit (CPU) 1404e of the baseband circuitry 1404 may be configured to run elements of the protocol stack for signaling of the PHY, MAC, RLC, PDCP and/or RRC layers. In some embodiments, the baseband circuitry may include one or more audio digital signal processor(s) (DSP) 1404f. The audio DSP(s) 1404f may be include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some or all of the constituent components of the baseband circuitry 1404 and the application circuitry 1402 may be implemented together such as, for example, on a system on a chip (SOC).

In some embodiments, the baseband circuitry 1404 may provide for communication compatible with one or more radio technologies. For example, in some embodiments, the baseband circuitry 1404 may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry 1404 is configured to support radio communications of more than one wireless protocol may be referred to as multi-mode baseband circuitry.

RF circuitry 1406 may enable communication with wireless networks using modulated electromagnetic radiation through a non-solid medium. In various embodiments, the RF circuitry 1406 may include switches, filters, amplifiers, etc. to facilitate the communication with the wireless network. RF circuitry 1406 may include a receive signal path which may include circuitry to down-convert RF signals received from the FEM circuitry 1408 and provide baseband signals to the baseband circuitry 1404. RF circuitry 1406 may also include a transmit signal path which may include circuitry to up-convert baseband signals provided by the baseband circuitry 1404 and provide RF output signals to the FEM circuitry 1408 for transmission.

In some embodiments, the RF circuitry 1406 may include a receive signal path and a transmit signal path. The receive signal path of the RF circuitry 1406 may include mixer circuitry 1406a, amplifier circuitry 1406b and filter circuitry 1406c. The transmit signal path of the RF circuitry 1406 may include filter circuitry 1406c and mixer circuitry 1406a. RF circuitry 1406 may also include synthesizer circuitry 1406d for synthesizing a frequency for use by the mixer circuitry 1406a of the receive signal path and the transmit signal path. In some embodiments, the mixer circuitry 1406a of the receive signal path may be configured to down-convert RF signals received from the FEM circuitry 1408 based on the synthesized frequency provided by synthesizer circuitry 1406d. The amplifier circuitry 1406b may be configured to amplify the down-converted signals and the filter circuitry 1406c may be a low-pass filter (LPF) or band-pass filter (BPF) configured to remove unwanted signals from the down-converted signals to generate output baseband signals. Output baseband signals may be provided to the baseband circuitry 1404 for further processing. In some embodiments, the output baseband signals may be zero-frequency baseband signals, although this is not a requirement. In some embodiments, mixer circuitry 1406a of the receive signal path may comprise passive mixers, although the scope of the embodiments is not limited in this respect.

In some embodiments, the mixer circuitry 1406a of the transmit signal path may be configured to up-convert input baseband signals based on the synthesized frequency provided by the synthesizer circuitry 1406d to generate RF output signals for the FEM circuitry 1408. The baseband signals may be provided by the baseband circuitry 1404 and may be filtered by filter circuitry 1406c. The filter circuitry 1406c may include a low-pass filter (LPF), although the scope of the embodiments is not limited in this respect.

In some embodiments, the mixer circuitry 1406a of the receive signal path and the mixer circuitry 1406a of the transmit signal path may include two or more mixers and may be arranged for quadrature downconversion and/or upconversion respectively. In some embodiments, the mixer circuitry 1406a of the receive signal path and the mixer circuitry 1406a of the transmit signal path may include two or more mixers and may be arranged for image rejection (e.g., Hartley image rejection). In some embodiments, the mixer circuitry 1406a of the receive signal path and the mixer circuitry 1406a may be arranged for direct downconversion and/or direct upconversion, respectively. In some embodiments, the mixer circuitry 1406a of the receive signal path and the mixer circuitry 1406a of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 1406 may include analog-to-digital converter (ADC) and digital-to-analog converter (DAC) circuitry and the baseband circuitry 1404 may include a digital baseband interface to communicate with the RF circuitry 1406.

In some dual-mode embodiments, a separate radio IC circuitry may be provided for processing signals for each spectrum, although the scope of the embodiments is not limited in this respect.

In some embodiments, the synthesizer circuitry 1406d may be a fractional-N synthesizer or a fractional N/N+1 synthesizer, although the scope of the embodiments is not limited in this respect as other types of frequency synthesizers may be suitable. For example, synthesizer circuitry 1406d may be a delta-sigma synthesizer, a frequency multiplier, or a synthesizer comprising a phase-locked loop with a frequency divider.

The synthesizer circuitry 1406d may be configured to synthesize an output frequency for use by the mixer circuitry 1406a of the RF circuitry 1406 based on a frequency input and a divider control input. In some embodiments, the synthesizer circuitry 1406d may be a fractional N/N+1 synthesizer.

In some embodiments, frequency input may be provided by a voltage controlled oscillator (VCO), although that is not a requirement. Divider control input may be provided by either the baseband circuitry 1404 or the applications processor 1402 depending on the desired output frequency. In some embodiments, a divider control input (e.g., N) may be determined from a look-up table based on a channel indicated by the applications processor 1402.

Synthesizer circuitry 1406d of the RF circuitry 1406 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, synthesizer circuitry 1406d may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (f_{LO}). In some embodiments, the RF circuitry 1406 may include an IQ/polar converter.

FEM circuitry 1408 may include a receive signal path which may include circuitry configured to operate on RF signals received from one or more antennas 1410, amplify the received signals and provide the amplified versions of the received signals to the RF circuitry 1406 for further processing. FEM circuitry 1408 may also include a transmit signal path which may include circuitry configured to amplify signals for transmission provided by the RF circuitry 1406 for transmission by one or more of the one or more antennas 1410.

In some embodiments, the FEM circuitry 1408 may include a TX/RX switch to switch between transmit mode and receive mode operation. The FEM circuitry may include a receive signal path and a transmit signal path. The receive signal path of the FEM circuitry may include a low-noise amplifier (LNA) to amplify received RF signals and provide the amplified received RF signals as an output (e.g., to the RF circuitry 1406). The transmit signal path of the FEM circuitry 1408 may include a power amplifier (PA) to amplify input RF signals (e.g., provided by RF circuitry 1406), and one or more filters to generate RF signals for subsequent transmission (e.g., by one or more of the one or more antennas 1410.

In some embodiments, the UE device 1400 may include additional elements such as, for example, memory/storage, display, camera, sensor, and/or input/output (I/O) interface.

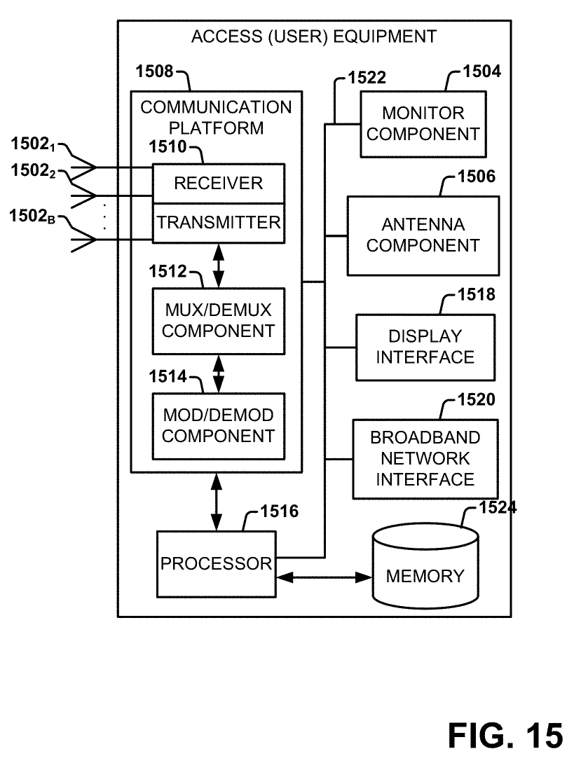

To provide further context for various aspects of the disclosed subject matter, FIG. 15 illustrates a block diagram of an embodiment of access (or user) equipment related to access of a network (e.g., network device, base station, wireless access point, femtocell access point, and so forth) that can enable and/or exploit features or aspects disclosed herein.

Access equipment (e.g., eNB, network entity, or the like), UE or software related to access of a network can receive and transmit signal(s) from and to wireless devices, wireless ports, wireless routers, etc. through segments 1502₁-1502_{B} (B is a positive integer). Segments 1502₁-1502_{B} can be internal and/or external to access equipment and/or software related to access of a network, and can be controlled by a monitor component 1504 and an antenna component 1506. Monitor component 1504 and antenna component 1506 can couple to communication platform 1508, which can include electronic components and associated circuitry that provide for processing and manipulation of received signal(s) and other signal(s) to be transmitted.

In an aspect, communication platform 1508 includes a receiver/transmitter 1510 that can convert analog signals to digital signals upon reception of the analog signals, and can convert digital signals to analog signals upon transmission. In addition, receiver/transmitter 1510 can divide a single data stream into multiple, parallel data streams, or perform the reciprocal operation. Coupled to receiver/transmitter 1510 can be a multiplexer/demultiplexer 1512 that can facilitate manipulation of signals in time and frequency space. Multiplexer/demultiplexer 1512 can multiplex information (data/traffic and control/signaling) according to various multiplexing schemes such as time division multiplexing, frequency division multiplexing, orthogonal frequency division multiplexing, code division multiplexing, space division multiplexing. In addition, multiplexer/demultiplexer component 1512 can scramble and spread information (e.g., codes, according to substantially any code known in the art, such as Hadamard-Walsh codes, Baker codes, Kasami codes, polyphase codes, and so forth).

A modulator/demodulator 1514 is also a part of communication platform 1508, and can modulate information according to multiple modulation techniques, such as frequency modulation, amplitude modulation (e.g., M-ary quadrature amplitude modulation, with M a positive integer); phase-shift keying; and so forth).

Access equipment and/or software related to access of a network also includes a processor 1516 configured to confer, at least in part, functionality to substantially any electronic component in access equipment and/or software. In particular, processor 1516 can facilitate configuration of access equipment and/or software through, for example, monitor component 1504, antenna component 1506, and one or more components therein. Additionally, access equipment and/or software can include display interface 1518, which can display functions that control functionality of access equipment and/or software or reveal operation conditions thereof. In addition, display interface 1518 can include a screen to convey information to an end user. In an aspect, display interface 1518 can be a liquid crystal display, a plasma panel, a monolithic thin-film based electrochromic display, and so on. Moreover, display interface 1518 can include a component (e.g., speaker) that facilitates communication of aural indicia, which can also be employed in connection with messages that convey operational instructions to an end user. Display interface 1518 can also facilitate data entry (e.g., through a linked keypad or through touch gestures), which can cause access equipment and/or software to receive external commands (e.g., restart operation).

Broadband network interface 1520 facilitates connection of access equipment and/or software to a service provider network (not shown) that can include one or more cellular technologies (e.g., third generation partnership project universal mobile telecommunication system, global system for mobile communication, and so on) through backhaul link(s) (not shown), which enable incoming and outgoing data flow. Broadband network interface 1520 can be internal or external to access equipment and/or software and can utilize display interface 1518 for end-user interaction and status information delivery.

Processor 1516 can be functionally connected to communication platform 1508 and can facilitate operations on data (e.g., symbols, bits, or chips) for multiplexing/demultiplexing, such as effecting direct and inverse fast Fourier transforms, selection of modulation rates, selection of data packet formats, inter-packet times, and so on. Moreover, processor 1516 can be functionally connected, through data, system, or an address bus 1522, to display interface 1518 and broadband network interface 1520, to confer, at least in part, functionality to each of such components.

In access equipment and/or software memory 1524 can retain location and/or coverage area (e.g., macro sector, identifier(s)) access list(s) that authorize access to wireless coverage through access equipment and/or software sector intelligence that can include ranking of coverage areas in the wireless environment of access equipment and/or software, radio link quality and strength associated therewith, or the like. Memory 1524 also can store data structures, code instructions and program modules, system or device information, code sequences for scrambling, spreading and pilot transmission, access point configuration, and so on. Processor 1516 can be coupled (e.g., through a memory bus), to memory 1524 in order to store and retrieve information used to operate and/or confer functionality to the components, platform, and interface that reside within access equipment and/or software.

As it employed in the subject specification, the term “processor” can refer to substantially any computing processing unit or device including, but not limited to including, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit, a digital signal processor, a field programmable gate array, a programmable logic controller, a complex programmable logic device, a discrete gate or transistor logic, discrete hardware components, or any combination thereof designed to perform the functions and/or processes described herein. Processors can exploit nano-scale architectures such as, but not limited to, molecular and quantum-dot based transistors, switches and gates, in order to optimize space usage or enhance performance of mobile devices. A processor may also be implemented as a combination of computing processing units.

In the subject specification, terms such as “store,” “data store,” data storage,” “database,” and substantially any other information storage component relevant to operation and functionality of a component and/or process, refer to “memory components,” or entities embodied in a “memory,” or components including the memory. It is noted that the memory components described herein can be either volatile memory or nonvolatile memory, or can include both volatile and nonvolatile memory.

By way of illustration, and not limitation, nonvolatile memory, for example, can be included in a memory, non-volatile memory (see below), disk storage (see below), and memory storage (see below). Further, nonvolatile memory can be included in read only memory, programmable read only memory, electrically programmable read only memory, electrically erasable programmable read only memory, or flash memory. Volatile memory can include random access memory, which acts as external cache memory. By way of illustration and not limitation, random access memory is available in many forms such as synchronous random access memory, dynamic random access memory, synchronous dynamic random access memory, double data rate synchronous dynamic random access memory, enhanced synchronous dynamic random access memory, Synchlink dynamic random access memory, and direct Rambus random access memory. Additionally, the disclosed memory components of systems or methods herein are intended to include, without being limited to including, these and any other suitable types of memory.

Examples can include subject matter such as a method, means for performing acts or blocks of the method, at least one machine-readable medium including instructions that, when performed by a machine cause the machine to perform acts of the method or of an apparatus or system for concurrent communication using multiple communication technologies according to embodiments and examples described herein.

Example 1 is an apparatus for use evolved NodeB (eNB) communicatively coupled to a multi-radio heterogeneous network of a radio access network (RAN). The apparatus comprises a memory storing executable instructions that execute one or more computer executable components and a processor configured to execute the executable instructions for the one or more executable components. The components comprise a proportion component configured to determine different data amounts of bearer traffic data corresponding to a plurality of communication links of the multi-radio heterogeneous network based on a set of heterogeneous network metrics, wherein the plurality of communication links comprise a 3GPP communication link and one or more other multi-radio links of the multi-radio heterogeneous network. A splitter component configured to separate a 3GPP bearer based on the different data amounts and provide the different data amounts of the 3GPP bearer over the plurality of communication links.

Example 2 includes the subject matter of Example 1, wherein the proportion component is further configured to determine a ratio associated with the bearer traffic data to be transmitted across the plurality of communication links for one or more user equipment (UE) devices communicatively coupled to the multi-radio heterogeneous network based on at least one of respective PHY/MAC data rates, queue utilizations, backhaul delays, buffer drain rates, or buffer levels at the plurality of communication links, available to the one or more UE devices.

Example 3 includes the subject matter of any one of Examples 1-2, including or omitting optional elements, wherein the proportion component is further configured to receive the set of heterogeneous network metrics from a UE device via a long-term evolution (LTE) link, wherein the UE device is configured to aggregate data from the multi-radio heterogeneous network and estimate the set of heterogeneous network metrics comprising at least one of a queue utilization, a physical/media access control (PHY/MAC) data rate, or a backhaul delay at an associated wireless local area network access point (WLAN AP).

Example 4 includes the subject matter of any one of Examples 1-3, including or omitting optional elements, further comprising: a ratio update component configured to update one or more splitting ratios related to the different data amounts of bearer traffic data by iteratively increasing a first portion of the bearer traffic data sent over an LTE link for a UE in response to a total weighted delay over a WiFi link being greater than over the LTE link, and by iteratively increasing a second portion of bearer traffic data sent over the WiFi link for the UE in response to the total weighted delay over the LTE link being greater than over the LTE link.

Example 5 includes the subject matter of any one of Examples 1-4, including or omitting optional elements,wherein the ratio update component is further configured to increase the first portion with a first step size as function of a direct proportion to a PHY/MAC rate associated with the LTE link and an inverse proportion to an LTE base station (BS) utilization, and increase the second portion with a second step size as a function of another direct proportion to the PHY/MAC rate associated with the LTE link and another inverse proportion to a WiFi utilization.

Example 6 includes the subject matter of any one of Examples 1-5, including or omitting optional elements, wherein the proportion component is further configured to update one or more splitting ratios related to the different data amounts based on a drain rate of the plurality of communication links of the multi-radio heterogeneous network.

Example 7 includes the subject matter of any one of Examples 1-6, including or omitting optional elements, wherein the splitter component is further configured to split the 3GPP bearer over a WLAN communication link and an LTE link, and the proportion component is further configured to update one or more splitting ratios related to the different data amounts based on an equalization of a buffer level at the plurality of communication links of the multi-radio heterogeneous network.

Example 8 includes the subject matter of any one of Examples 1-7, including or omitting optional elements, further comprising: a feedback component configured to exchange feedback information with a WLAN AP via an Xw interface over a user plane or control plane protocol.

Example 9 includes the subject matter of any one of Examples 1-8, including or omitting optional elements,wherein the user plane protocol comprises a general packet radio service tunneling protocol user plane (GTP-U) protocol and the control plane protocol comprises a Xw application protocol (Xw-AP).

Example 10 includes the subject matter of any one of Examples 1-9, including or omitting optional elements, further comprising: a feedback component configured to receive the set of heterogeneous network metrics from UE feedback information.

Example 11 includes the subject matter of any one of Examples 1-3, including or omitting optional elements, wherein the feedback component is further configured to receive the UE feedback information based on extensions of a packet data convergence protocol (PDCP) status report of a UE device via a long-term evolution (LTE) link.

Example 12 is a computer-readable media comprising executable instructions that, in response to execution, cause a system comprising one or more processors to perform operations in a multi-radio heterogeneous network of a radio access network (RAN), comprising: determining, via the one or more processors, one or more ratios of bearer traffic data corresponding to a plurality of communication links of the multi-radio heterogeneous network based on a set of heterogeneous network metrics, wherein the plurality of communication links comprise a 3GPP communication link and one or more other multi-radio links of the multi-radio heterogeneous network operating in a different protocol than the 3GPP communication link; dividing, via the one or more processors, a 3GPP bearer into different fractions as a function of the one or more ratios of bearer traffic data; and communicating, via the one or more processors, a first fraction of the different fractions of the 3GPP bearer over the 3GPP communication link and a second fraction of the different fractions of the 3GPP bearer over the one or more other multi-radio links.

Example 13 includes the subject matter of Example 12, including or omitting optional elements, wherein the determining the one or more ratios of bearer traffic data comprises determining fractions of a 3GPP bearer to be transmitted among the plurality of communication links to one or more user equipment (UE) devices communicatively coupled to the multi-radio heterogeneous network based on at least one of respective PHY/MAC data rates, queue utilizations, backhaul delays, buffer drain rates, or buffer levels at the plurality of communication links, available to the one or more UE devices.

Example 14 includes the subject matter of any one of Examples 12-13, including or omitting optional elements, wherein the operations further comprise: receiving the set of heterogeneous network metrics from a UE device via a long-term evolution (LTE) link, wherein the set of heterogeneous network metrics comprise at least one of a queue utilization, a PHY/MAC data rate, or a backhaul delay at an associated wireless local area network access point (WLAN AP).

Example 15 includes the subject matter of any one of Examples 12-14, including or omitting optional elements, wherein the dividing the 3GPP bearer comprises communicating the first fraction of the different fractions of the 3GPP bearer to a WLAN link and the second fraction of the different fractions to an LTE link.

Example 16 includes the subject matter of any one of Examples 12-15, including or omitting optional elements, further comprising: updating the one or more ratios corresponding to different data amounts of bearer traffic data between the 3GPP communication link and the one or more other multi-radio links of the multi-radio heterogeneous network by iteratively increasing the first fraction of the 3GPP bearer sent over an LTE link for a UE in response to a total weighted delay over a WiFi link being greater than over the LTE link, and by iteratively increasing a second portion of bearer traffic data sent over the WiFi link for the UE in response to the total weighted delay over the LTE link being greater than over the LTE link.

Example 17 includes the subject matter of any one of Examples 12-16, including or omitting optional elements, wherein the operations further comprise: increasing the first fraction with a first step size that is directly proportional to a PHY/MAC rate associated with an LTE link and inversely proportional to an LTE base station (BS) utilization, and increasing the second portion with a second step size the is directly proportional to the PHY/MAC rate associated with the LTE link and inversely proportional to a WiFi utilization.

Example 18 includes the subject matter of any one of Examples 12-17, including or omitting optional elements, wherein the operations further comprise: updating the one or more ratios based on drain rates of the plurality of communication links of the multi-radio heterogeneous network.

Example 19 includes the subject matter of any one of Examples 12-18, including or omitting optional elements, wherein the operations further comprise: updating the one or more ratios based on buffer levels associated with the plurality of communication links of the multi-radio heterogeneous network.

Example 20 includes the subject matter of any one of Examples 12-19, including or omitting optional elements, wherein the operations further comprise: exchanging UE feedback information with a WLAN AP via an Xw interface over a user plane protocol or a control plane protocol, wherein the user plane protocol comprises a general packet radio service tunneling protocol user plane (GTP-U) protocol and the control plane protocol comprises an Xw application protocol (Xw-AP).

Example 21 includes the subject matter of any one of Examples 12-20, including or omitting optional elements, wherein the operations further comprise: receiving the set of heterogeneous network metrics from UE feedback information utilizing extensions of a packet data convergence protocol (PDCP) status report of a UE device via a long-term evolution (LTE) link.

Example 22 is an apparatus for use in a user equipment (UE) device coupled to a multi-radio heterogeneous network of a radio access network (RAN). The apparatus comprises a memory storing executable instructions that execute one or more computer executable components and a processor configured to execute the executable instructions for the one or more executable components. The components comprise a proportion component configured to determine different data amounts of bearer traffic data corresponding to a plurality of communication links of the multi-radio heterogeneous network based on a set of heterogeneous network metrics, wherein the plurality of communication links comprise a 3GPP communication link and one or more other multi-radio links of the multi-radio heterogeneous network; and a metric component configured to transmit the set of heterogeneous network metrics to an eNB, or one or more other UEs coupled to the multi-radio heterogeneous network, wherein the set of heterogeneous network metrics comprise one or more of a plurality of PHY/MAC data rates, a plurality of queue utilizations, a plurality of backhaul delays, a plurality of buffer drain rates, or a plurality of buffer levels at the plurality of communication links, which are respectively available to the one or more other UEs coupled to the multi-radio heterogeneous network.

Example 23 includes the subject matter of Example 22, including or omitting optional elements, further comprising: a receiving component configured to receive an amount of the different data amounts of a 3GPP bearer over the 3GPP communication link based on a ratio of the 3GPP bearer associated with the one or more other multi-radio links of the multi-radio heterogeneous network.

Example 24 includes the subject matter of any one of Examples 21-22, including or omitting optional elements, wherein the metric component is further configured to aggregate the bearer traffic data that is being communicated across the multi-radio heterogeneous network, and estimate a queue utilization, a PHY/MAC data rate, or a backhaul delay at an associated wireless local area network access point (WLAN AP).

Example 25 includes the subject matter of any one of Examples 21-22, including or omitting optional elements, further comprising: a feedback component configured to communicate the set of heterogeneous network metrics via extensions of a packet data convergence protocol (PDCP) status report via a long-term evolution (LTE) link.

Example 26 is a system for a network device in a multi-radio heterogeneous network according to a RAN anchored multi-Radio integration model. The system comprises a means for splitting of a 3GPP bearer and sending appropriate proportions of the bearer traffic over the 3GPP and other multi-radio links in the network; a means for determining the proportion of the traffic to be transmitted on each link dynamically or statically.

Example 27 includes the subject matter of Example 26, including or omitting optional elements, system of claim 26, wherein the splitting of the bearer occurs over the WLAN and LTE link.

Example 28 includes the subject matter of any one of Examples 26-27, including or omitting optional elements, further comprising a use equipment (UE) operating in a multi-radio heterogeneous network, wherein the UE is configured to aggregate data sent across the multi-radio heterogeneous network and estimate the queue utilization, PHY rates, and backhaul delay at the associated WLAN AP sending the above metrics to an evolved NodeB (eNB) via a long term evolution (LTE) link.

It is to be understood that aspects described herein can be implemented by hardware, software, firmware, or any combination thereof. When implemented in software, functions can be stored on or transmitted over as one or more instructions or code on a computer-readable medium. Computer-readable media includes both computer storage media and communication media including any medium that facilitates transfer of a computer program from one place to another. A storage media or a computer readable storage device can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or other tangible and/or non-transitory medium, that can be used to carry or store desired information or executable instructions. Also, any connection is properly termed a computer-readable medium. For example, if software is transmitted from a website, server, or other remote source using a coaxial cable, fiber optic cable, twisted pair, digital subscriber line (DSL), or wireless technologies such as infrared, radio, and microwave, then coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Various illustrative logics, logical blocks, modules, and circuits described in connection with aspects disclosed herein can be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform functions described herein. A general-purpose processor can be a microprocessor, but, in the alternative, processor can be any conventional processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration. Additionally, at least one processor can comprise one or more modules operable to perform one or more of the s and/or actions described herein.

For a software implementation, techniques described herein can be implemented with modules (e.g., procedures, functions, and so on) that perform functions described herein. Software codes can be stored in memory units and executed by processors. Memory unit can be implemented within processor or external to processor, in which case memory unit can be communicatively coupled to processor through various means as is known in the art. Further, at least one processor can include one or more modules operable to perform functions described herein.

Techniques described herein can be used for various wireless communication systems such as CDMA, TDMA, FDMA, OFDMA, SC-FDMA and other systems. The terms “system” and “network” are often used interchangeably. A CDMA system can implement a radio technology such as Universal Terrestrial Radio Access (UTRA), CDMA1800, etc. UTRA includes Wideband-CDMA (W-CDMA) and other variants of CDMA. Further, CDMA1800 covers IS-1800, IS-95 and IS-856 standards. A TDMA system can implement a radio technology such as Global System for Mobile Communications (GSM). An OFDMA system can implement a radio technology such as Evolved UTRA (E-UTRA), Ultra Mobile Broadband (UMB), IEEE 802.11 (Wi-Fi), IEEE 802.16 (WiMAX), IEEE 802.18, Flash-OFDML, etc. UTRA and E-UTRA are part of Universal Mobile Telecommunication System (UMTS). 3GPP Long Term Evolution (LTE) is a release of UMTS that uses E-UTRA, which employs OFDMA on downlink and SC-FDMA on uplink. UTRA, E-UTRA, UMTS, LTE and GSM are described in documents from an organization named “3rd Generation Partnership Project” (3GPP). Additionally, CDMA1800 and UMB are described in documents from an organization named “3rd Generation Partnership Project 2” (3GPP2). Further, such wireless communication systems can additionally include peer-to-peer (e.g., mobile-to-mobile) ad hoc network systems often using unpaired unlicensed spectrums, 802.xx wireless LAN, BLUETOOTH and any other short- or long-range, wireless communication techniques.

Single carrier frequency division multiple access (SC-FDMA), which utilizes single carrier modulation and frequency domain equalization is a technique that can be utilized with the disclosed aspects. SC-FDMA has similar performance and essentially a similar overall complexity as those of OFDMA system. SC-FDMA signal has lower peak-to-average power ratio (PAPR) because of its inherent single carrier structure. SC-FDMA can be utilized in uplink communications where lower PAPR can benefit a mobile terminal in terms of transmit power efficiency.

Moreover, various aspects or features described herein can be implemented as a method, apparatus, or article of manufacture using standard programming and/or engineering techniques. The term “article of manufacture” as used herein is intended to encompass a computer program accessible from any computer-readable device, carrier, or media. For example, computer-readable media can include but are not limited to magnetic storage devices (e.g., hard disk, floppy disk, magnetic strips, etc.), optical disks (e.g., compact disk (CD), digital versatile disk (DVD), etc.), smart cards, and flash memory devices (e.g., EPROM, card, stick, key drive, etc.). Additionally, various storage media described herein can represent one or more devices and/or other machine-readable media for storing information. The term “machine-readable medium” can include, without being limited to, wireless channels and various other media capable of storing, containing, and/or carrying instruction(s) and/or data. Additionally, a computer program product can include a computer readable medium having one or more instructions or codes operable to cause a computer to perform functions described herein.

Communications media embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

Further, the actions of a method or algorithm described in connection with aspects disclosed herein can be embodied directly in hardware, in a software module executed by a processor, or a combination thereof. A software module can reside in RAM memory, flash memory, ROM memory, EPROM memory, EEPROM memory, registers, a hard disk, a removable disk, a CD-ROM, or any other form of storage medium known in the art. An exemplary storage medium can be coupled to processor, such that processor can read information from, and write information to, storage medium. In the alternative, storage medium can be integral to processor. Further, in some aspects, processor and storage medium can reside in an ASIC. Additionally, ASIC can reside in a user terminal. In the alternative, processor and storage medium can reside as discrete components in a user terminal. Additionally, in some aspects, the s and/or actions of a method or algorithm can reside as one or any combination or set of codes and/or instructions on a machine-readable medium and/or computer readable medium, which can be incorporated into a computer program product.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

In particular regard to the various functions performed by the above described components (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations of the disclosure. In addition, while a particular feature may have been disclosed with respect to only one of several implementations, such feature may be combined with one or more other features of the other implementations as may be desired and advantageous for any given or particular application.

1-25. (canceled)

26. An apparatus for use evolved NodeB (eNB) communicatively coupled to a multi-radio heterogeneous network of a radio access network (RAN), comprising:
a proportion component configured to determine different data amounts of bearer traffic data corresponding to a plurality of communication links of the multi-radio heterogeneous network based on a set of heterogeneous network metrics, wherein the plurality of communication links comprise a 3GPP communication link and one or more other multi-radio links of the multi-radio heterogeneous network; and
a splitter component configured to separate a 3GPP bearer based on the different data amounts and provide the different data amounts of the 3GPP bearer over the plurality of communication links.

27. The apparatus of claim 26, wherein the proportion component is further configured to determine a ratio associated with the bearer traffic data to be transmitted across the plurality of communication links for one or more user equipment (UE) devices communicatively coupled to the multi-radio heterogeneous network based on at least one of respective physical/media access control (PHY/MAC) data rates, queue utilizations, backhaul delays, buffer drain rates, or buffer levels at the plurality of communication links, available to the one or more UE devices.

28. The apparatus of claim 26, wherein the proportion component is further configured to receive the set of heterogeneous network metrics from a UE device via a long-term evolution (LTE) link, wherein the UE device is configured to aggregate data from the multi-radio heterogeneous network and estimate the set of heterogeneous network metrics comprising at least one of a queue utilization, a PHY/MAC data rate, or a backhaul delay at an associated wireless local area network access point (WLAN AP).

29. The apparatus of claim 26, further comprising:
a ratio update component configured to update one or more splitting ratios related to the different data amounts of bearer traffic data by iteratively increasing a first portion of the bearer traffic data sent over an LTE link for a UE in response to a total weighted delay over a WiFi link being greater than over the LTE link, and by iteratively increasing a second portion of bearer traffic data sent over the WiFi link for the UE in response to the total weighted delay over the LTE link being greater than over the LTE link.

30. The apparatus of claim 29, wherein the ratio update component is further configured to increase the first portion with a first step size as function of a direct proportion to a PHY/MAC rate associated with the LTE link and an inverse proportion to an LTE base station (BS) utilization, and increase the second portion with a second step size as a function of another direct proportion to the PHY/MAC rate associated with the LTE link and another inverse proportion to a WiFi utilization.

31. The apparatus of claim 26, wherein the proportion component is further configured to update one or more splitting ratios related to the different data amounts based on a drain rate of the plurality of communication links of the multi-radio heterogeneous network.

32. The apparatus of claim 26, wherein the splitter component is further configured to split the 3GPP bearer over a WLAN communication link and an LTE link, and the proportion component is further configured to update one or more splitting ratios related to the different data amounts based on an equalization of a buffer level at the plurality of communication links of the multi-radio heterogeneous network.

33. The apparatus of claim 26, further comprising:
a feedback component configured to exchange feedback information with a WLAN AP via an Xw interface over a user plane or control plane protocol.

34. The apparatus of claim 33, wherein the user plane protocol comprises a general packet radio service tunneling protocol user plane (GTP-U) protocol and the control plane protocol comprises a Xw application protocol (Xw-AP).

35. The apparatus of claim 26, further comprising:
a feedback component configured to receive the set of heterogeneous network metrics from UE feedback information.

36. The apparatus of claim 35, wherein the feedback component is further configured to receive the UE feedback information based on extensions of a packet data convergence protocol (PDCP) status report of a UE device via a long-term evolution (LTE) link.

37. A computer-readable media comprising executable instructions that, in response to execution, cause a system comprising one or more processors to perform operations in a multi-radio heterogeneous network of a radio access network (RAN), comprising:
determining, via the one or more processors, one or more ratios of bearer traffic data corresponding to a plurality of communication links of the multi-radio heterogeneous network based on a set of heterogeneous network metrics, wherein the plurality of communication links comprise a 3GPP communication link and one or more other multi-radio links of the multi-radio heterogeneous network operating in a different protocol than the 3GPP communication link;
dividing, via the one or more processors, a 3GPP bearer into different fractions as a function of the one or more ratios of bearer traffic data; and
communicating, via the one or more processors, a first fraction of the different fractions of the 3GPP bearer over the 3GPP communication link and a second fraction of the different fractions of the 3GPP bearer over the one or more other multi-radio links.

38. The computer-readable media of claim 37, wherein the determining the one or more ratios of bearer traffic data comprises determining fractions of a 3GPP bearer to be transmitted among the plurality of communication links to one or more user equipment (UE) devices communicatively coupled to the multi-radio heterogeneous network based on at least one of respective physical/media access control (PHY/MAC) data rates, queue utilizations, backhaul delays, buffer drain rates, or buffer levels at the plurality of communication links, available to the one or more UE devices.

39. The computer-readable media of claim 37, wherein the operations further comprise:
receiving the set of heterogeneous network metrics from a UE device via a long-term evolution (LTE) link, wherein the set of heterogeneous network metrics comprise at least one of a queue utilization, a PHY/MAC data rate, or a backhaul delay at an associated wireless local area network access point (WLAN AP).

40. The computer-readable media of claim 37, wherein the dividing the 3GPP bearer comprises communicating the first fraction of the different fractions of the 3GPP bearer to a WLAN link and the second fraction of the different fractions to an LTE link.

41. The computer-readable media of claim 37, further comprising:
updating the one or more ratios corresponding to different data amounts of bearer traffic data between the 3GPP communication link and the one or more other multi-radio links of the multi-radio heterogeneous network by iteratively increasing the first fraction of the 3GPP bearer sent over an LTE link for a UE in response to a total weighted delay over a WiFi link being greater than over the LTE link, and by iteratively increasing a second portion of bearer traffic data sent over the WiFi link for the UE in response to the total weighted delay over the LTE link being greater than over the LTE link.

42. The computer-readable media of claim 37, wherein the operations further comprise:
increasing the first fraction with a first step size that is directly proportional to a PHY/MAC rate associated with an LTE link and inversely proportional to an LTE base station (BS) utilization, and increasing the second portion with a second step size the is directly proportional to the PHY/MAC rate associated with the LTE link and inversely proportional to a WiFi utilization.

43. The computer-readable media of claim 37, wherein the operations further comprise:
updating the one or more ratios based on drain rates of the plurality of communication links of the multi-radio heterogeneous network.

44. The computer-readable media of claim 37, wherein the operations further comprise:
updating the one or more ratios based on buffer levels associated with the plurality of communication links of the multi-radio heterogeneous network.

45. The computer-readable media of claim 37, wherein the operations further comprise:
exchanging UE feedback information with a WLAN AP via an Xw interface over a user plane protocol or a control plane protocol, wherein the user plane protocol comprises a general packet radio service tunneling protocol user plane (GTP-U) protocol and the control plane protocol comprises an Xw application protocol (Xw-AP).

46. The computer-readable media of claim 37, wherein the operations further comprise:
receiving the set of heterogeneous network metrics from UE feedback information utilizing extensions of a packet data convergence protocol (PDCP) status report of a UE device via a long-term evolution (LTE) link.

47. An apparatus for use in a user equipment (UE) device coupled to a multi-radio heterogeneous network of a radio access network (RAN), the apparatus comprising:
a proportion component configured to determine different data amounts of bearer traffic data corresponding to a plurality of communication links of the multi-radio heterogeneous network based on a set of heterogeneous network metrics, wherein the plurality of communication links comprise a 3GPP communication link and one or more other multi-radio links of the multi-radio heterogeneous network; and
a metric component configured to transmit the set of heterogeneous network metrics to an eNB, or one or more other UEs coupled to the multi-radio heterogeneous network, wherein the set of heterogeneous network metrics comprise one or more of a plurality of physical/media access control (PHY/MAC) data rates, a plurality of queue utilizations, a plurality of backhaul delays, a plurality of buffer drain rates, or a plurality of buffer levels at the plurality of communication links, which are respectively available to the one or more other UEs coupled to the multi-radio heterogeneous network.

48. The apparatus of claim 47, further comprising:
a receiving component configured to receive an amount of the different data amounts of a 3GPP bearer over the 3GPP communication link based on a ratio of the 3GPP bearer associated with the one or more other multi-radio links of the multi-radio heterogeneous network.

49. The apparatus of claim 48, wherein the metric component is further configured to aggregate the bearer traffic data that is being communicated across the multi-radio heterogeneous network, and estimate a queue utilization, a PHY/MAC data rate, or a backhaul delay at an associated wireless local area network access point (WLAN AP).

50. The apparatus of claim 49, further comprising:
a feedback component configured to communicate the set of heterogeneous network metrics via extensions of a packet data convergence protocol (PDCP) status report via a long-term evolution (LTE) link.
